(19) United States
(12) Patent Application Publication
(10) Pub. No.: US 2013/0166059 A1
(43) Pub. Date: Jun. 27, 2013

(54) NUMERICAL CONTROL DEVICE

(71) Applicants: Koji Terada, Tokyo (JP); Masakazu Sagasaki, Tokyo (JP)

(72) Inventors: Koji Terada, Tokyo (JP); Masakazu Sagasaki, Tokyo (JP)

(73) Assignee: MITSUBISHI ELECTRIC CORPORATION, Tokyo (JP)

(21) Appl. No.: 13/695,507

(22) PCT Filed: Jun. 14, 2011
(86) PCT No.: PCT/JP11/03367

§ 371 Date: Oct. 31, 2012

(51) Int. Cl. G05B 19/4103

(52) U.S. Cl. CPC G05B 19/4103
USPC 700/189

(57) ABSTRACT

A numerical control device that controls a machine in which a main set including an X1 axis, a Z1 axis and a first turret axis and a sub-set including an X2 axis, a Z2 axis and a second turret axis are arranged to be point-symmetric with respect to a C axis, wherein each of the turret axis of the main set and the turret axis of the sub-set are selectively designated as a reference side and a synchronized side and a simultaneous D-cut control mode command for selecting a mode in which both turret axes are simultaneously actuated in synchronization using the output of the turret axis of one of the sets is set; wherein the numerical control device comprises, simultaneous D-cut command processing means, X1/Y1/C axis interpolation processing means, X2/Y2 axis interpolation processing means, and H axis command selecting means.

### TECHNICAL FIELD

The present invention relates to a workpiece machining technique using a numerically-controlled turning machine which is controlled by a numerical control (hereinafter, also abbreviated as NC) device. More particularly, the present invention relates to an eccentric machining process, that is, a so-called D-cut, of performing a machining process on a plane that is separated from the rotation center of a workpiece and parallel to a plane in a workpiece diameter direction perpendicular to the XZ plane in a turning process.

### BACKGROUND ART

In related art, as a type of a turning machine, a machine has been known having a C axis that holds a workpiece and of which a rotational position is controlled, an X axis of which a position is controlled to become close to or far from the center of the C axis, a Z axis that similarly moves in an axis direction of the C axis, and a turret axis (H axis) that is driven by the X axis and the Z axis and that can rotate at any angle while being perpendicular to the axis line of the C axis. Such a turning machine can perform a planar machining process in a circumferential direction of the workpiece by the use of a virtual Y axis which is not actually present, in addition to a normal turning process. This machining process is called a D-cut, in that a cross-section similar to the letter D is obtained by linearly cutting off a part of a circular cross-section.

In order to implement this machining process, a plane separated from the center by an arbitrary distance in the radius direction of a workpiece held on the C axis is imagined, a rotating tool on the H axis is made to face the center of the C axis, the H axis rotates so as to direct the tool in the direction of the center of the C axis with respect to the position separated from the center of the C axis and the C axis rotates so as to be perpendicular to the tool. The machining process is implemented by performing this series of controls continuously from one end to the other end of a plane imagined on the circumference of a workpiece on the C axis so that a speed along the virtual Y axis becomes a command speed. The position of the X axis is controlled depending on a distance of a tool tip (=machining surface) from the center of the workpiece.

Patent Reference 1 discloses that a rotational motion of a C axis and a rotational motion of a tool (turret axis) are mechanically synchronized to implement the above-mentioned machining process. Patent Reference 2 discloses a configuration of a machine having six sets, each of which has a configuration implementing the same operation as described above through the use of overall servo control, and an operating method thereof. These patent references describe the mechanical structure or the operations of the respective elements, whereby it is possible to perform a so-called D-cut under the control thereof.

Machining details similar to the D-cut are shown in Patent Reference 3, but since it is a machine having an X axis, a Z axis, a main axis/C axis, and a fixed-angle identifying turret, even when Y axis control is required, it is converted into a C axis angle through polar coordinate transformation. Thus, even though a machining point locus is correct, for example, when a machining process is performed by using a flat end mill, the central part of a workpiece is machined in a planar shape but as it gets closer to both ends, an arc-like cut in the cutting surface becomes large according to the tool diameter, whereby the machining surface is not ensured. Accordingly, it can be said that Patent Reference 3 does not provide a configuration or structure by which a machining process can actually be performed.

### PRIOR ART REFERENCE

### Patent Reference

[Patent Reference 1] JP-B-H03-033441 (related description: line 32 of column 16 of page 8 to line 28 of column 17 of page 9, line 18 of column 18 of page 9 to line 29 of column 19 of page 10, FIG. 3 and FIG. 7)
[Patent Reference 2] JP-A-2000-218422 (related description: lines 25 to 34 of column 7 of page 5, line 25 of column 18 of page 10 to line 32 of column 19 of page 11, FIGS. 7 to 11)
[Patent Reference 3] JP-A-S60-044239 (related description: lines 7 to 15 of column 1 of page 3, line 16 of column 4 of page 7 to line 7 of column 1 of page 8, lines 6 to 18 of column 3 of page 10, FIG. 11, the linear shape in FIG. 12, and FIG. 42)

### DISCLOSURE OF INVENTION

### Technical Problem

On the other hand, a double D-cut (may be referred to as a spanner cut, in that the cross-section of a machined workpiece has a shape similar to the opening of a spanner) of machining into a shape where both sides of a circular cross-section is cut-off is known. Although such a machining process can also be performed by performing the D-cut on the same workpiece twice, since the machining time will be doubled, there arose a demand of simultaneously machining both sides so as to enhance machining efficiency.

In the D-cut, one side of the circular cross-section of the workpiece is cut off in a linear shape. However, there arose a demand for performing a D-cut in which the circular cross-section of a workpiece is cut off in a curved shape such as a convex arc or a concave arc (in the specification, to simplify the distinction, each of these are called a (linear) D-cut and an arc-like D-cut).

In the machine structure of the related art having a set of XZHC axes shown in FIG. 14, a turret axis (H axis) that can rotate in the circumferential direction of an X axis direction (in the radius direction of a workpiece) is disposed to be movable in the X axis direction with respect to the C axis holding the workpiece and the rotation of the H axis can be controlled to a desired angle. According to this configuration, by synchronously rotating the H axis and the C axis by an equal angle and causing a rotating tool of the H axis to approach and separate in the X axis direction in synchronization with the rotation, it is possible to perform a machining process such as cutting or punching with a plane imagined at a position separated from the center of the workpiece.

Note that, since the movement direction of the Z axis is perpendicular to the XY plane and the movement plane of the H axis and the C axis and does not affect the basic operations of the invention, although the Z axis will be mentioned as an axis name, the operation thereof will not be described herein.

FIG. 15 shows an example where a so-called double D-cut machining process of cutting off both ends in the diameter direction of a cylindrical body is performed by the use of a machine having the configuration shown in FIG. 14.

Specifically, in a state where a tool is replaced with a milling tool and a C axis mode is selected, a double D-cut machining process is performed by controlling the machine as follows.

(1) The tool direction and the X axis direction of a virtual plane are made to be parallel to each other.

(2) A virtual Y axis interpolation mode command (to cancel a synchronous feed mode and to select the XY plane of an end face machining process).

(3) The tool is made to move to a machining start position.

(4) A milling process is performed (the C axis and the H axis are simultaneously controlled).

(5) The tool direction and the X axis direction of the virtual plane are made to be parallel to each other.

(6) The virtual Y axis interpolation mode is cancelled.

(7) The workpiece is inverted (C axis).

(8) The virtual Y axis interpolation mode command.

(9) The tool is made to move to a machining start position.

(10) A milling process is performed (the C axis and the H axis are simultaneously controlled).

(11) The tool direction and the X axis direction of the virtual plane are made to be parallel to each other.

(12) The virtual Y axis interpolation mode is cancelled.

By controlling the machine in this way, the double D-cut machining process is performed. However, at the time point at which the D-cut machining process on one side is ended, the virtual Y axis interpolation mode is temporarily cancelled, the C axis is inverted, and then the D-cut machining process should be performed again on the opposite side in the virtual Y axis interpolation mode, whereby there is a problem in that the machining time is long.

On the contrary, as shown in FIG. 1, there could be a machine that performs a linear or arc-like double D-cut machining process in a short machining time by arranging a main set including an X1 axis, a Z1 axis, and a first turret axis (H1 axis) and a sub-set including an X2 axis, a Z2 axis, and a second turret axis (H2 axis) to be point symmetric with respect to a C axis and simultaneously controlling the main set and the sub-set. In FIG. 1, Tx represents the tool length and Ty represents the tool radius.

However, conventionally, a numerical control device that can control this new machine did not exist. That is, a numerical control device, which can simultaneously perform a linear or arc-like double D-cut machining process by simultaneously controlling the main set including an X1 axis, a Z1 axis, and a first turret axis (H1 axis) and the sub-set including an X2 axis, a Z2 axis, and a second turret axis (H2 axis) did not exist.

An object of the invention is to provide a numerical control device that can control a machine having the above-mentioned new configuration so as to perform a linear or arc-like double D-cut machining process in a short machining time.

Another object of the invention is to provide a numerical control device that can control a machine having the above-mentioned new configuration so as to accurately perform a linear or arc-like double D-cut machining process in a short machining time, even when tools mounted on the turrets have different dimensional data (such as a tool length and a tool diameter) and the rotational angles of the two turret axes are different from each other or the amounts of machining movement of two turret axes are different from each other.

### Means for Solving the Problem

An numerical control device of the invention is a numerical control device that controls a machine in which a main set including an X1 axis, a Z1 axis and a first turret axis and a sub-set including an X2 axis, a Z2 axis and a second turret axis are arranged to be point-symmetric with respect to a C axis, wherein each of the turret axis of the main set and the turret axis of the sub-set are selectively designated as a reference side and a synchronized side and a simultaneous D-cut control mode command for selecting a mode in which both turret axes are simultaneously actuated in synchronization using the output of the turret axis of one of the sets is set; wherein the numerical control device includes, simultaneous D-cut command processing means for analyzing and executing the simultaneous D-cut control mode command, X1/Y1/C axis interpolation processing means for performing an interpolation process on the main set, X2/Y2 axis interpolation processing means for performing an interpolation process on the sub-set, and H axis command selecting means for selecting from which of the main set and the sub-set to acquire rotational angle control data of the turret axes and the C axis; and wherein when the simultaneous D-cut control mode command is executed, the H axis command selecting means selects from which of the main set and the sub-set to acquire the rotational angle control data of the turret axes and the C axis, and the machine is controlled to simultaneously perform a D-cut machining process on to surfaces of a workpiece held by the C axis based on the selected data.

Further, the numerical control device of the invention further includes: turret axis calculation reference determining means for comparing a turret axis angle of the main set having a tool mounted thereon and a turret axis angle of the sub-set having a tool mounted thereon with each other and determining whether both turret axis angles are different from each other; and re-calculation control processing means for re-calculating an actual amount of movement of the tool and re-calculating a command speed to be given to the turret axis having the larger turret axis angle so that the smaller turret axis angle becomes equal to the larger turret axis angle when the turret axis calculation reference determining means determines that both turret axis angles are different from each other, wherein the H axis command selecting means selects the set having the smaller turret axis angle from which the rotational angle control data of both turret axes and the C axis are obtained.

Further, the numerical control device of the invention further includes: turret axis calculation reference determining means for comparing an actual amount of movement of a tool of the main set having the tool mounted thereon and an actual amount of movement of a tool of the sub-set having the tool mounted thereon with each other and determining whether the actual amounts of movement of the tools of both turret axes are different from each other; and re-calculation control processing means for re-calculating a command speed to be given to the turret axis having the smaller amount of movement when the turret axis calculation reference determining means determines that the actual amounts of movement of the tools of both turret axes after correction of the tools are different from each other, wherein the H axis command selecting means selects the set having the larger actual amount of movement of the tool from which the rotational angle control data of both turret axes and the C axis are obtained.

### Technical Solution

According to the invention, since the main set and the sub-set in the machine in which the main set including an X1 axis, a Z1 axis, and a first turret axis and the sub-set including an X2 axis, a Z2 axis, and a second turret axis are arranged to be point symmetric with respect to a C axis can be simultaneously controlled, it is possible to perform a linear or arc-like double D-cut machining process in approximately half the time of the related art.

Further, according to the invention, it is possible to accurately perform a linear or arc-like double D-cut machining process in a short time reduced to a half, even when tools mounted on the turrets have different dimensional data (such as a tool length and a tool diameter) and the rotational angles of two turret axes are different from each other or the amounts of machining movement of the two turret axes are different from each other.

### BRIEF DESCRIPTION OF DRAWINGS

FIG. 1 is a diagram illustrating the configuration of a machine according to the invention and an operational example of a simultaneous D-cut machining process thereof.

FIG. 2 is a diagram illustrating the simultaneous D-cut machining process under a virtual Y axis control according to Embodiment 1, where tools mounted on turret 1 and turret 2 have the same dimensional data.

FIG. 3 is a diagram illustrating the simultaneous D-cut machining process under a virtual Y axis control according to Embodiment 2, where tools mounted on turret 1 and turret 2 are different from each other in tool length.

FIG. 4 is a diagram illustrating the simultaneous D-cut machining process under a virtual Y axis control according to Embodiment 2, where tools mounted on turret 1 and turret 2 are different from each other in tool diameter.

FIG. 5 is a diagram illustrating the simultaneous D-cut machining process under a virtual Y axis control according to Embodiment 2, where tools mounted on turret 1 and turret 2 are different from each other in tool length and tool diameter.

FIG. 6 is a flowchart illustrating the simultaneous D-cut control under the virtual Y axis control according to Embodiment 1 of the invention.

FIG. 7 is a block diagram illustrating the configuration of a numerical control device according to Embodiment 1 of the invention.

FIG. 8 is a block diagram illustrating the configuration of a numerical control device according to Embodiment 2 of the invention.

FIG. 9 is a flowchart illustrating the simultaneous D-cut control under the virtual Y axis control according to Embodiment 2 of the invention.

FIG. 10 is a diagram illustrating a simultaneous arc-like D-cut machining process according to Embodiment 3 of the invention.

FIG. 11 is a block diagram illustrating the configuration of a numerical control device according to Embodiment 3 of the invention.

FIG. 12 is a diagram illustrating the simultaneous arc-like D-cut machining process under a virtual Y axis control according to Embodiment 3, where tools mounted on turret 1 and turret 2 have the same dimensional data.

FIG. 13 is a diagram illustrating the simultaneous arc-like D-cut machining process under a virtual Y axis control according to Embodiment 3, where tools mounted on turret 1 and turret 2 have different dimensional data.

FIG. 14 is a diagram illustrating the axis configuration of the machine of the related art performing a D-cut machining process.

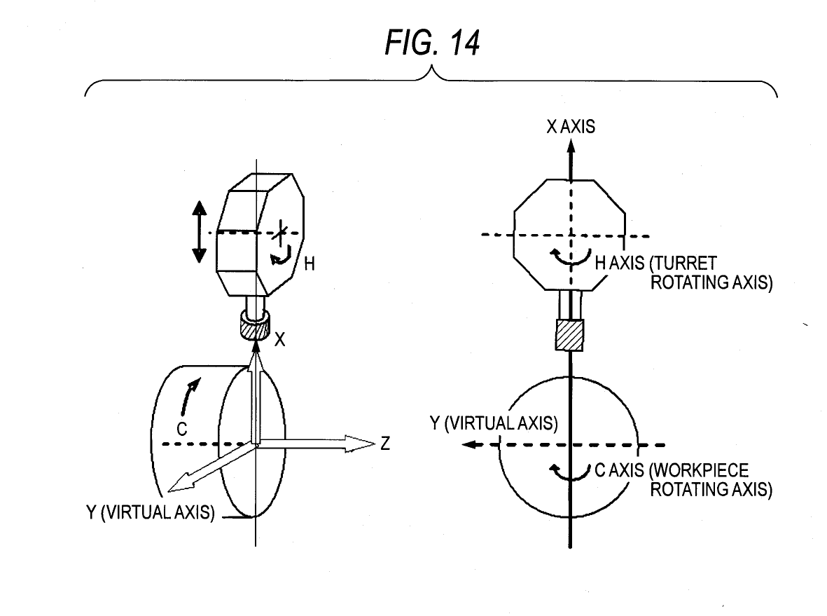

FIG. 15 is a diagram illustrating the operational example of a double D-cut machining process using the machine of the related art.

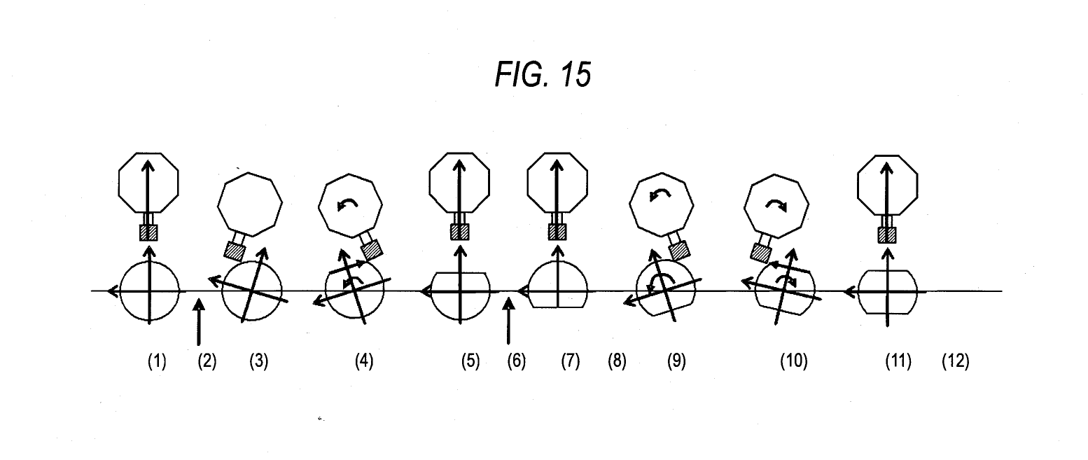

### BEST MODE FOR CARRYING OUT THE INVENTION

### Embodiment 1

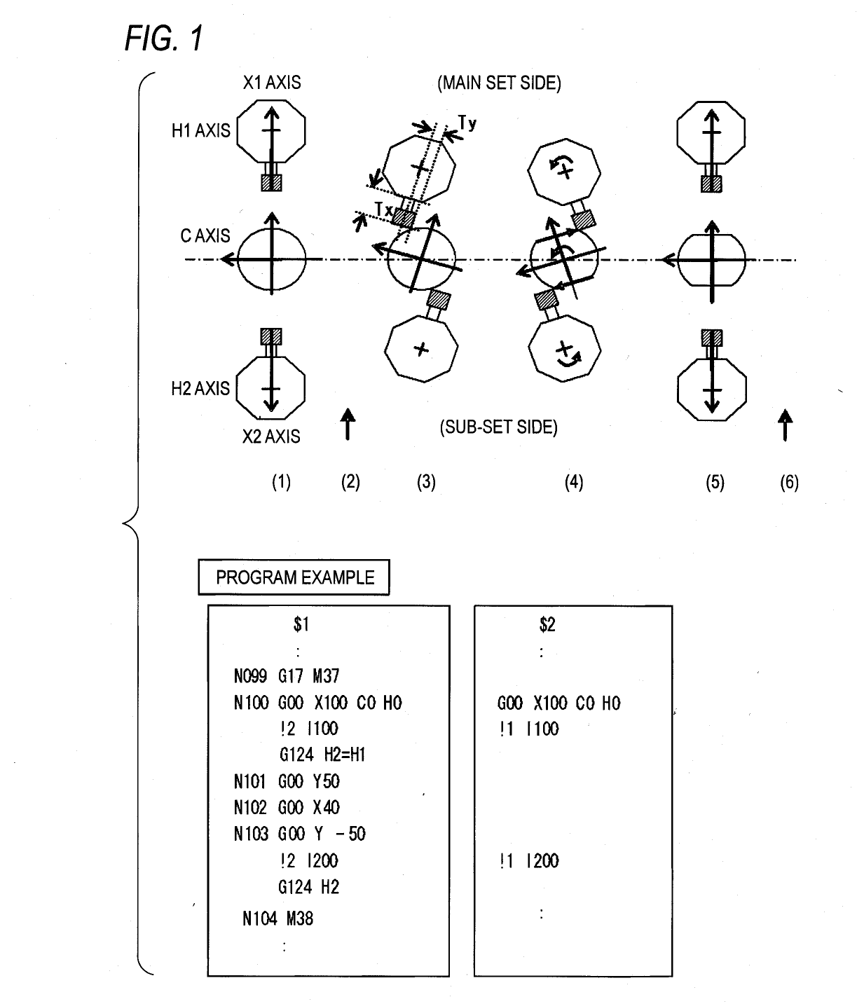

Hereinafter, Embodiment 1 of the invention will be described with reference to FIGS. 1, 2, 6, and 7.

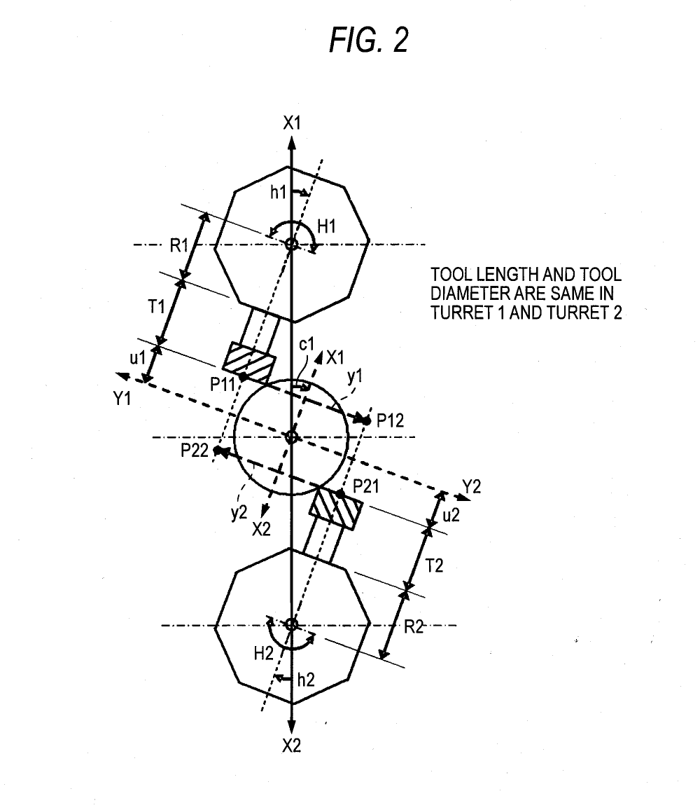

In Embodiment 1, as shown in FIG. 2, tools mounted on turret 1 and turret 2 have the same dimensional data (such as tool length and tool diameter).

FIG. 1 shows a simultaneous D-cut machining process which is performed by controlling a machine having a new configuration (a machine in which a main set including an X1 axis, Z1 axis, and a first turret axis (H1 axis) and a sub-set including an X2 axis, a Z2 axis, and a second turret axis (H2 axis) are arranged to be point symmetric with respect to a C axis) according to Embodiment 1 of the invention. FIG. 1 also shows program examples of the respective systems. A reference axis and a synchronized axis move identically to simultaneously perform a D-cut machining process based on the details of the blocks with sequence numbers N101 to N103, thereby simultaneously machining both side surfaces.

Virtual Y axis machining (control) is required for performing the D-cut machining process with the machine, but as prior preparation for the virtual Y axis machining process, it is necessary to replace the tools with milling tools and to switch a main axis from a speed loop control mode to a C axis control mode which is a position loop control mode as prior preparation of the virtual Y axis machining.

In performing a double D-cut machining process with the machine shown in FIG. 1, first, the tool direction and the X axis direction of a virtual plane are made to be parallel to each other as shown in FIG. 1 (G0Xx1C0H0; is given to each system). A tool tip (center) is located at a position separated x1 in the X axis direction from the C axis center and the C axis and the H axis are positioned relatively at 0 amounts in response to the command (the state of (1) in FIG. 1).

After the positioning is performed on both the main set and the sub-set, a virtual Y axis interpolation mode command (for example, M37) is given by the machining process of the main set (system 1 $1) to establish the virtual Y axis interpolation mode, a command G17 of selecting an XY plane in which biaxial interpolation is performed with two axes of X and Y is given, and a command (for example, when “!2” is given to the main set and “! 1” is given to the sub-set using a command “!”, the main set and the sub-set are synchronously on standby) of causing the main set and the sub-set (system 2 $2) to be synchronously on standby is given.

Regarding these commands, as shown in the program example of FIG. 1, the command G17 of selecting an XY plane in which the biaxial interpolation is performed with two axes of X and Y and the virtual Y axis interpolation mode command (M37) of establishing the virtual Y axis interpolation mode may be first given and then a command (G0Xx1C0H0) causing the tool direction and the X axis direction of the virtual plane to be parallel to each other may be given.

Subsequently, a simultaneous D-cut control mode command (for example, a command G124 H2=H1; newly defined to control the H2 axis of the sub-set with H1 axis data of the main set) is given (the state of (2) in FIG. 1).

When a positioning command to a machining start position (the coordinate value of the virtual Y axis) is given, the angle of the C axis is calculated so that the center of a cutting edge of the tool is located at the position of the virtual Y axis, which set in the coordinate system, of an end face of the workpiece, the C axis and the H axis are made to rotate, and the center of the H axis moves along the X axis. When the amount of displacement of the D-cut surface from the C axis center is commanded as Xul, the tool center is made to move so that the tool tip matches the virtual Y axis of the rotated C axis (the state of (3) in FIG. 1). Then, when the end point on the virtual Y axis is designated by a straight line, a milling process along the virtual Y axis is performed linearly from the machining start position to the end point (the state of (4) in FIG. 1). Subsequently, the tool is retracted to a position at which the workpiece and the tool do not interfere with each other and the tool direction, the X axis direction of the virtual plane are matched with each other (the state of (5) in FIG. 1), a command (for example, G124 H2) of cancelling the simultaneous D-cut control mode is given, and a command (for example, M38) cancelling the virtual Y axis interpolation mode is given (the state of (6) in FIG. 1).

In this way, the simultaneous D-cut machining process can be performed on both sides of a workpiece using the machining program of one cutting process to the main set (system 1). However, this control is possible only when tools having the same dimensional data are mounted on the turret axes of the main set and the sub-set. In the simultaneous D-cut machining process, the sub-set performs interpolating calculation or real-axis coordinate transformation using the program values commanded for the main set and turret 1, turret 2, and the C axis can synchronously perform the simultaneous D-cut machining process by inputting X axis data to the X2 axis, inputting the X axis data calculated for the main set to the X1 axis, and inputting the H axis data to the H1 axis, the H2 axis, and the C axis.

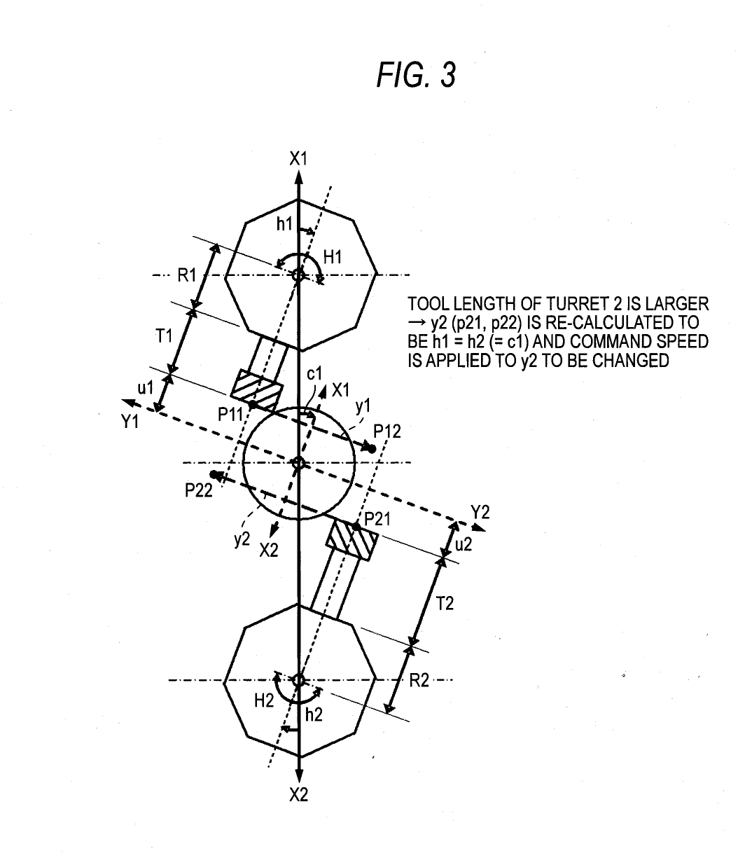

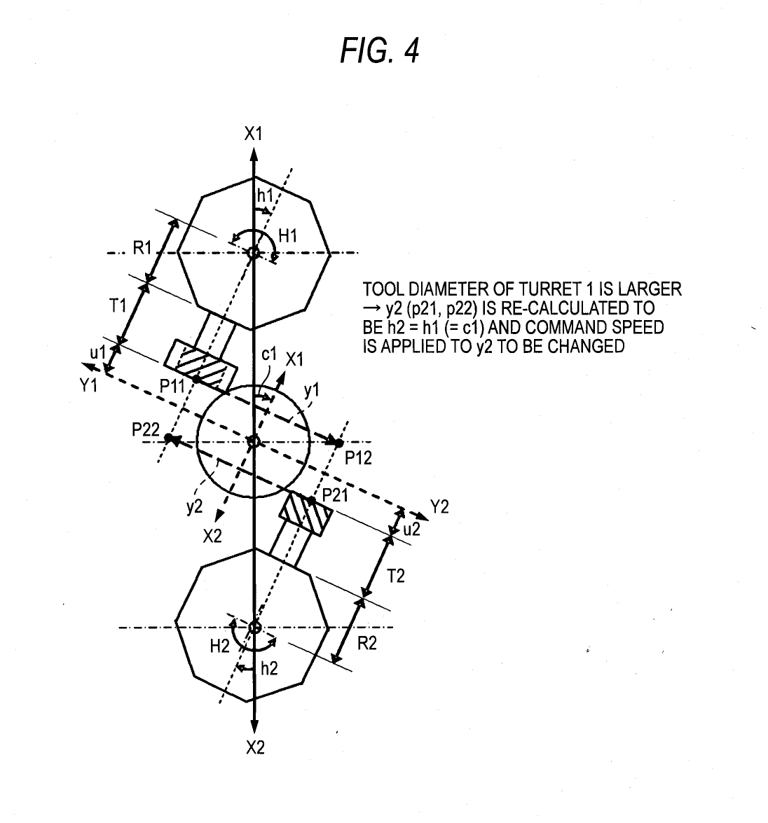

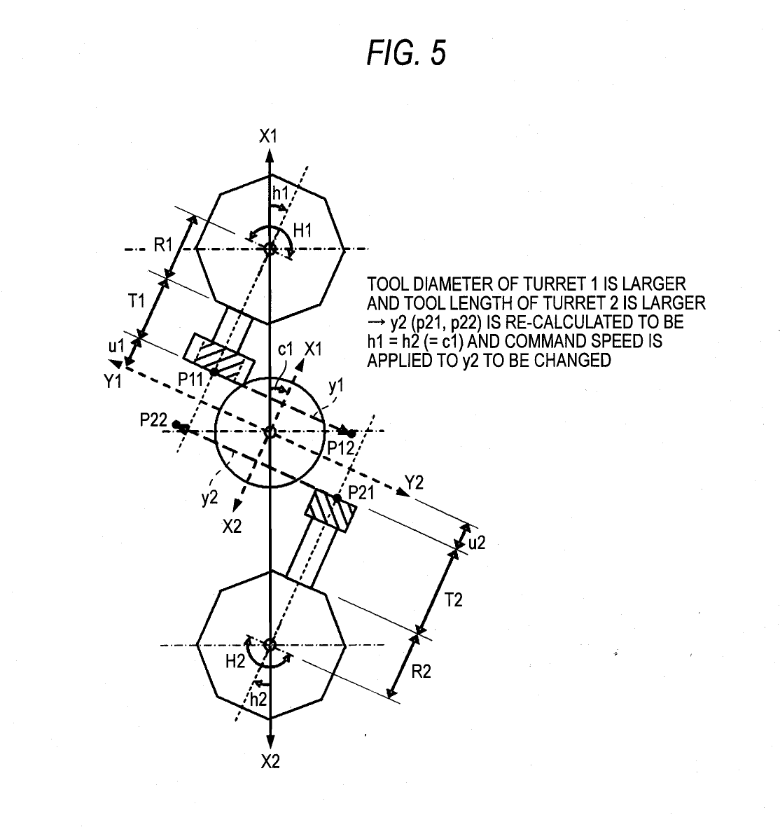

FIGS. 2 to 5 show various relationships between both turrets and control data of the workpiece, where FIG. 2 shows a case where tools having the same tool length and the same tool diameter are mounted on both turrets, FIG. 3 shows a case where the tool length of the tool mounted on turret 2 is larger than the tool length of the tool mounted on turret 1, FIG. 4 shows a case where the tool diameter of the tool mounted on turret 1 is larger than the tool diameter of the tool mounted on turret 2, and FIG. 5 shows a case where the tool length of the tool mounted on turret 2 is larger than the tool length of the tool mounted on turret 1 and the tool diameter of the tool mounted on turret 1 is larger than the tool diameter of the tool mounted on turret 2.

In FIGS. 2 to 5, R1 and R2 represent the distances from the rotation centers of the turret axes to the tool-mounted positions, T1 and T2 represent the tool lengths, and u1 and u2 represent the amounts of displacement of the machining surfaces from the center of the workpiece. When the machining start position in the virtual Y axis is designated in the machining program, tool length correction and tool diameter correction are performed, the tool center position p11 is calculated, and the rotational angle (h1=C1) of the C axis and the H1 axis and the distance from the center of the C axis to the center of the H1 axis corresponding thereto are calculated, whereby the respective axes move to the machining start position.

Since the turret axis rotational angle h1 and h2 in FIGS. 2 to 5 are angles to one side about 0 amounts the amounts of cutting movement y1 and y2 of the turret axes need be calculated using double the angles h1 and h2.

When a machining end point is designated in the machining program, p12 is similarly obtained and a line y1 connecting p11 and p12 is linearly interpolated in the virtual XY plane. In the sub-set, similarly to the main set, p21 is obtained and a line y2 connecting p21 and p22 is linearly interpolated in the virtual XY plane. By converting the interpolation data into real-axis positions of the X axis and the H axis (rotation axis) and outputting the resultant position to the servo control units of the axes to drive the servomotors, the rotation of the C axis, the rotation of the turrets, and the movement of the turret axes with respect to the C axis are controlled in cooperation. As a result, a planar machining process and a punching process can be performed on a plane perpendicular to the radius direction at a position separated from the center of the workpiece by a designated distance.

In FIG. 2, since the tools mounted on both turrets are the same, the amounts of cutting movement y1 and y2 are the same and the cutting speeds thereof are the same. Accordingly, since the rotational angles and the rotation speeds of the H1 axis and the H2 axis are the same, the rotational angles and the rotation speeds of the H1 axis and the H2 axis can be forcibly matched by inputting the rotation data of the H1 axis of the main set to the H2 axis without any change, thereby simultaneously performing the D-cut machining process without any problem.

When performing the D-cut machining process in this way, it is necessary to make the rotational angles of the H1 axis, the H2 axis, and the C axis to be equal to each other. However, when the tool lengths and the tool diameters of the tools mounted on both sets are different from each other as shown in FIGS. 3, 4, and 5, y1 and y2 are not equal to each other and the cutting speeds thereof should be made to be different from each other, whereby the controls of the axes at the time of machining are in conflict with each other. A solution to this case will be described in Embodiment 2.

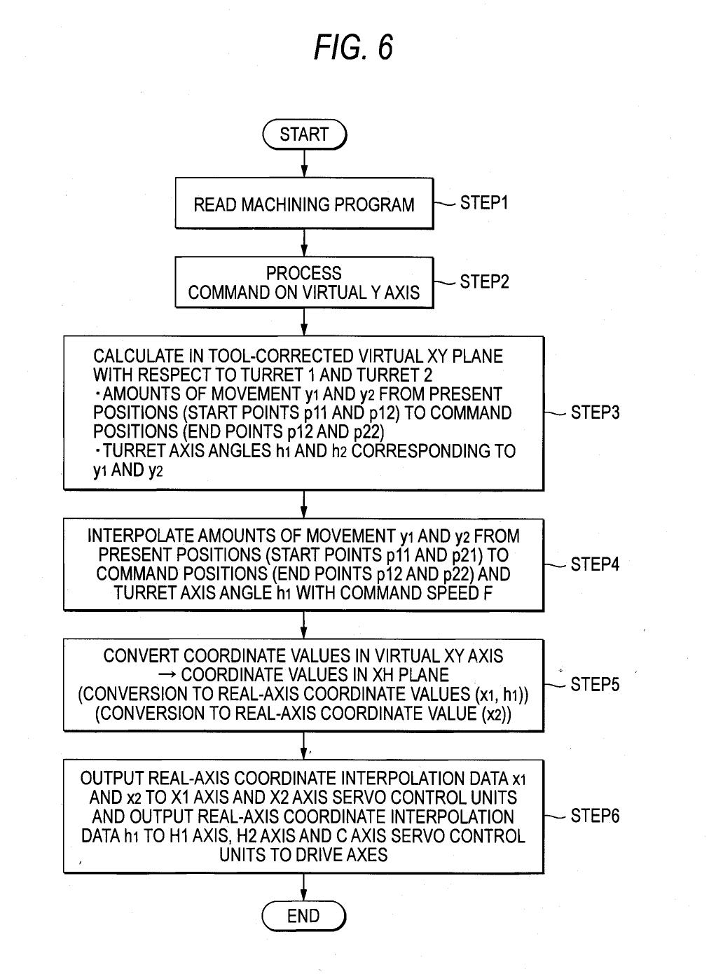

FIG. 6 shows an exemplary flowchart illustrating the flow of program processes in the NC according to Embodiment 1 of the invention.

A machining program is read in step 1, and a program command for the virtual Y axis is analyzed to perform a predetermined processing program in step 2. A virtual Y axis interpolation mode ON/OFF command, that is, M37/M38 in this embodiment, is used as the command for the virtual Y axis. In response to M37, a switching processing unit that enables the interpolating calculation in the virtual XY plane and that selects a machining process on the XZ plane as a normal turning machine and a machining process under the control using the virtual Y axis is activated. The method of outputting M37/M38 to the outside and inputting the command as an external input signal to the NC again through the use of a PLC (Programmable Logic Controller) is employed, but the command may be switched in the NC device.

In order to perform the simultaneous D-cut machining process, a G command such as G124 of selecting the input of an H axis command and a C axis command is newly added as another command. By designating H2=H1 subsequently to G124, the H2 axis is analyzed to be driven based on the H1 axis data. On the contrary, when H1=H2, the H1 axis is analyzed to be driven based on the H2 axis data. By designating only one of H1 and H2 subsequently to G124, these commands are cancelled. This G command can be set arbitrarily.

When the machining paths of two tools mounted in the same way are the same, the turret rotational angles and the rotation speeds are the same. Accordingly, by executing G124 H2=H1; as a basic command, the H1 axis is defined as the reference side and the H2 axis is defined as the synchronized side.

In step 3, regarding the command positions of the turret 1 and turret 2, the amounts of movement (lengths of virtual segments) y1 and y2 from the present positions p11 and p21 in the virtual XY plane to the tool-corrected command positions p12 and p22 and the turret axis angles h1 and h2 corresponding to y1 and y2 are calculated based on a positioning command of the machining program read in step 1. In FIG. 2, since p11, p12, p21, and p22 represent start points and end points of the cutting surfaces of the D-cut but are relative signs which are sequentially changed with the machining, they are not necessarily matched with the description of the flowcharts or the like. In Embodiment 1, the calculation of the turret axis angle h2 is not necessary. However, when the tool lengths or the tool diameters of the tools mounted on the turrets are different, it is necessary to calculate h2. Since a flexible NC device (which can be used when the tool lengths or the tool diameters of the tools mounted on the turrets are different) is used, the turret axis angle h2 is calculated necessarily.

In step 4, the amounts of movement y1 and y2 in the virtual XY plane and the turret axis angle h1 calculated in step 3 are interpolated with a programmed command speed F. In step 5, the interpolated values in the virtual XY coordinate system are converted into coordinate values in the XH plane which is a real axis to be actually controlled so as to drive a motor to be controlled.

In step 6, the amount of real-axis movement is calculated on real-axis coordinates which are converted from the coordinate values in the virtual XY plane to the coordinate values in the XH plane, the calculated amounts of movement are output to the servo control units of the axes, and the corresponding motors are driven so as for the machine to perform a desired machining process. The real-axis coordinate interpolation data x1 is output to the X1 servo control unit, the real-axis coordinate interpolation data x2 is output to the X2 servo control unit, and the real-axis coordinate interpolation data h1 is output to the H1-axis servo control unit, the H2-axis servo control unit, and the C-axis servo control unit to drive the X1 axis, the X2 axis, the H1 axis, the H2 axis, and the C axis, whereby the virtual Y axis control is performed.

By sequentially reading and analyzing the machining program in this way and simultaneously performing the D-cut machining process on both sides, it is possible to complete the machining in half the time of the related art.

In the machining program for the simultaneous D-cut machining process, since the shapes of the D-cut are the same, a shaping program gives a command to only the first system as shown in the program example of FIG. 1 and the command given to the first system is used in the axes of the second system. The temporal relationship between the start and the end of the actual simultaneous D-cut machining process or other machining processes in the first system or the second system is controlled using a synchronous standby command (for example, the command “!”).

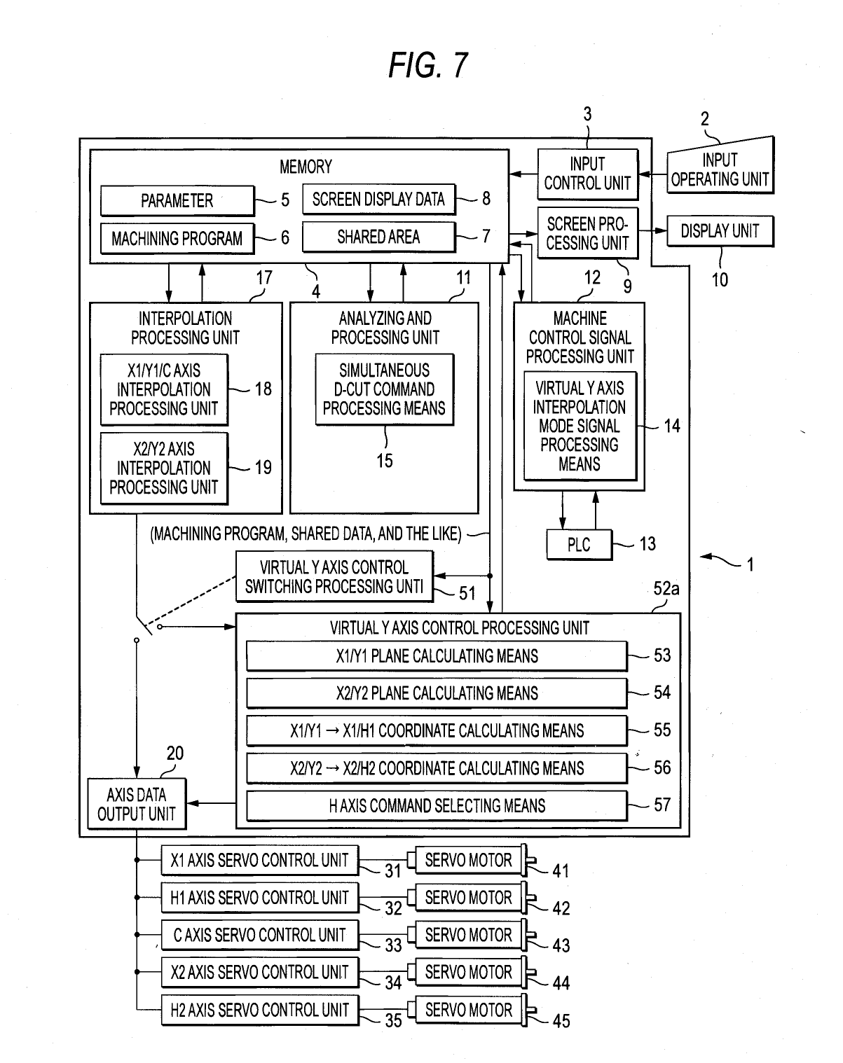

FIG. 7 is a block diagram illustrating an example of the configuration of the NC device according to Embodiment 1 of the invention, which can perform the processes of the machining program shown in FIG. 6.

In FIG. 7, reference sign 1 represents an NC device, reference sign 2 represents an input operation unit, reference sign 3 represents input control unit, reference sign 4 represents a memory, reference sign 5 represents a parameter storage unit, reference sign 6 represents a machining program storage unit, reference sign 7 represents a shared area, reference sign 8 represents a screen display data storage unit, reference sign 9 represents a screen processing unit, and reference sign 10 represents a display unit. Reference sign 11 represents an analyzing and processing unit, reference sign 12 represents a machine control signal processing unit, reference sign 13 represents a PLC, reference sign 14 represents a virtual Y axis interpolation mode signal processing unit, reference sign 15 represents a simultaneous D-cut command processing means, reference sign 17 represents an interpolation processing unit, reference sign 18 represents X1/Y1/C axis interpolation processing means, reference sign 19 represents X2/Y2 axis interpolation processing means, and reference sign 20 represents an axis data output unit. Reference signs 31 to 35 represent servo control units of X1, X2, H1, H2, and C axes, respectively, and reference signs 41 to 45 represent servomotors of X1, X2, H1, H2, and C axes, respectively. Reference sign 51 represents a Y axis control switching processing unit, reference sign 52a represents a first virtual Y axis control processing unit, reference sign 53 represents X1/Y1 plane calculation means, reference sign 54 represents X2/Y2 plane calculation means, reference sign 55 represents X1/Y1→X1/H1 coordinate calculating means, reference sign 56 represents X2/Y2→X2/H2 coordinate calculating means, and reference sign 57 represents H axis command selecting means.

The operations will be described below. In the NC device 1, the input control unit 3 senses a variation of a switch signal of the input operation unit 2 operated by an operator, accesses the parameter storage unit 5, the machining program storage unit 6, the shared area 7, and the screen display data area 8 in the memory 4, and gives writing or reading signals for changing the contents of the memory thereto. Various display data stored in predetermined addresses of the screen display data area 8 are read by the screen processing unit 9 and data are displayed at predetermined positions on the display unit 10.

The parameters stored in the parameter storage unit 5 include condition data necessary for determining the specification of the NC device or controlling the machine. In the machining program, operation details of the machine or moving paths of the cutting edge necessary for machining at least one workpiece are described and stored in the format which can be read by the NC device. The shared area 7 stores temporary data or the like necessary for analyzing the machining program or control of the system in control of the machine operation. The screen display data area 8 stores various data such as present position information, main axis rotation information, control modes of the NC device, and output states of various selection signals, which are designated through the use of the input operation unit 2 and which are required by the operator.

The analyzing and processing unit 11 sequentially reads a designated program out of the machining program stored in the machining program storage 6 from the head, temporarily stores data under process or the like in the shared area 7 with reference to the parameters 5 through processing sequences designated for various NC commands, and analyzes and executes the program.

The machine control signal processing unit 12 reads information on the control of the peripherals of the machine output from the analyzing and processing unit 11 to the memory 4, outputs the read information to the PLC 13 to give control information to a ladder circuit or outputs various control signals such as ON/OFF signals from an external input/output signal I/F not shown to the machine. Signals for control of various units of the NC device input from the PLC 13 or external signals input from the machine are written to the shared area 7 of the memory 4 and are applied to the control of the NC device to correctly perform the control of the NC device and the machine.

When switching the ON/OFF of the virtual Y axis interpolation mode in response to a selection signal input from the outside of the NC device, the virtual Y axis interpolation mode signal processing means 14 receives the external signal input to the machine control signal processing unit 12 and sets or resets predetermined parameters. This switching control may be performed in the NC device in response to the commands in the machining program. In Embodiment 1 of the invention, a method of converting the external signals into ON/OFF signals by the use of auxiliary commands (M37 and M38) and inputting the resultant signals to the NC device is employed.

The simultaneous D-cut command processing means 15 in the analyzing and processing unit 11 analyzes a command (“G124 synchronized turret axis name=reference turret axis name” in the invention; master-slave relationship information of the H1 axis and the H2 axis which are the rotating axes is given, for example, as H2=H1) for simultaneously performing a so-called D-cut machining process, which is known from the past, on both sides in the diameter direction of a workpiece using two systems of turret axes (steps 1 and 2 in FIG. 6). In order to most simply perform the simultaneous D-cut, as shown in at least FIG. 2, identical tools are similarly mounted on two turret axes arranged to be point symmetric with respect to the C axis, the positions (X axis) of two turret axes form the center of a workpiece are acquired through the interpolation of each system, and the H2 axis in rotating the turret axes is synchronously rotationally driven using drive data of the H1 axis as a reference axis. The C axis rotating the workpiece is synchronously driven using the drive data of the H1 axis as the reference axis, whereby the simultaneous D-cut can be embodied.

The interpolation processing unit 17 includes the X1/Y1/C axis interpolation processing means 18 and the X2/Y2 axis interpolation processing means 19. In the description of the invention, since the Z axis which is the length direction of the workpiece is not directly involved in the D-cut machining process, the Z axis is not shown and the operation thereof is not described. A program for moving a tool to the machining start position before performing the D-cut machining process or the simultaneous D-cut machining process is necessary, but it is assumed that the tool centers corrected with the command positions are located at positions p11 and p12, as shown in FIG. 2.

In the machining control of a normal turning machine, without performing a linear or arc interpolating process on the relative movement acquired from the machining program using the interpolation processing means of the X1 axis, the Z1 axis, the C axis, the X2 axis, and the Z2 axis not shown in the interpolation processing unit 17, the output data are input to the servo control units 31 to 35 of the axes via the axis data output unit 20, and the servomotors 41 to 45 are rotationally driven with the drive power output from the servo control units 31 to 35. Accordingly, the X and Z axes, the main axis, and the C axis of a turning machine which is a machine to be controlled are driven to perform a desired machining process.

In control of the virtual Y axis, the virtual Y axis control switching processing unit 51 is activated in response to the virtual Y axis interpolation mode signal input from the outside and switches the interpolation result of the interpolation processing unit 17 so as to be used in the first virtual Y axis control processing unit 52a.

The first virtual Y axis control processing unit 52a includes the X1/Y1 plane calculation means 53, the X2/Y2 plane calculation means 54, the X1/Y1→X1/H1 coordinate calculating means 55, the X2/Y2→X2/H2 coordinate calculating means 56, and the H axis command selecting means 57. The X1/Y1 plane calculation means 53 and the X2/Y2 plane calculation means 54 calculate the machining start points p11 and p21, the end points p12 and p22, the segment lengths y1 and y2, which are the tool-corrected tool center positions in the virtual XY plane, and the rotational angles h1 and h2 of the turrets from the machining programs of the systems and store the calculation result in the shared area 7 of the memory 4 (step 3 in FIG. 6).

The X1/Y1→X1/H1 coordinate calculating means 55 and the X2/Y2→X2/H2 coordinate calculating means 56 convert the coordinate values obtained by integrating the interpolation data output from the interpolation processing unit 17 into real-axis coordinate values in the XH axes corresponding to the actual machine based on the coordinate values created by the X1/Y1 plane calculation means 53 and the X2/Y2 plane calculation means 54 and the command speed, and convert the resultant into real-axis movement (increment value) which is an actual amount of movement in the real axes, so as to control the positions in the X axis direction of the turret axes and the rotation of the turret axes.

As described above, the H axis command selecting means 57 serves to select command data for rotationally driving the reference turret, the synchronized turret, and the C axis at the time of control of the simultaneous D-cut or to overlap the commands. The selection of the command data is determined in response to the command G124 given from the machining program.

Normal one-side D-cut control techniques are known and thus are not described in detail. A machining path in a virtual XY coordinate system including an X axis and a virtual Y axis is designated in the machining program and the interpolation is performed by the X1/Y1/C axis interpolation processing means 18 so that the tool-corrected tool center moves along a path y1 designated on the workpiece from the present position p11 to the end position p12 at a designated speed, thereby calculating the amounts of movement and the rotational angles of the X1 axis, the Y1 axis, and the C axis per unit time in the coordinate system of X1, Y1, the C axes. The X2/Y2 axis interpolation processing means 19 performs the interpolation so that the tool-corrected tool center moves along a path y2 designated on the workpiece from the present position p21 to the end position p22 at a designated speed, thereby calculating the amounts of movement of the X2 axis and the Y2 axis per unit time in the coordinate system of X2 and Y2 axes (step 4 in FIG. 6). The displacement of the X axis is the displacement of the turret axis from the center of the C axis and the displacement of the Y axis corresponds to the rotational angle of the turret axis (H axis). This displacement is performed by coordinate transformation to be described later. The angle of the H axis (the central axis direction of the tool) and the inclination of the C axis are controlled to be parallel to each other.

The interpolated positions of the X axis and the Y axis correspond to the lengths at any coordinate position, but the actual machine structure includes a translation axis and a rotating axis. Accordingly, the X1, X2, Y1, and Y2 data as the calculated positions in the virtual XY coordinate system are converted into real-axis coordinate values of the positions and the rotational angles by the X1/Y1→X1/H1 coordinate calculating means 55 and the X2/Y2→X2/H2 coordinate calculating means 56 to calculate the amounts of real-axis movement x1, x2, and h1 (step 5 in FIG. 6).

The axis data output unit 20 outputs the real-axis coordinate interpolation data x1 to the X1 servo control unit 31, outputs the real-axis coordinate interpolation data x2 to the X2 servo control unit 34, and outputs the real-axis coordinate interpolation data h1 to the H1 servo control unit 32, the H2 servo control unit 35, and the C servo control unit 33 in response to the command G124 to drive the X1 axis, the X2 axis, the H1 axis, the H2 axis, and the C axis, whereby the virtual Y axis control is performed to perform the simultaneous D-cut machining process (step 6 in FIG. 6).

As described above, in the simultaneous D-cut machining process, the turret axes of the systems are similarly interpolated and controlled in the same way, but the interpolation of the main (reference) side is performed to include the C axis and the interpolation of the sub (synchronized) side is performed on only the X axis and the Y axis.

Here, in the simultaneous D-cut machining process, the turret axis angle of the synchronized side can be made to move in the same way as the turret axis of the reference side by adding the real-axis movement of the turret axis of the reference side (the calculation result in the command is 0) to the turret axis command of the synchronized side in response to the command G124.

Through this control, the main (reference side) set performs the D-cut machining process on one side as in conventional art. In the sub (synchronized side) set, the interpolation or the coordinate transformation is performed in the same way by considering that the XY axis commands of the main side is given to the sub side, and the rotation of the turret axis is driven using the same data as the rotation of the turret axis of the main side, whereby the D-cut machining process can be simultaneously performed on the other side.

The calculated positions of the X axis and the Y axis after the interpolation correspond to the lengths at any coordinate position, but the actual machine structure includes the translation axis and the rotating axis. Accordingly, the X and Y data as the calculated positions in the virtual XY coordinate system are converted into real-axis coordinate values of the positions and the rotational angles by the X1/Y1→X1/H1 coordinate calculating means 55 and the X2/Y2→X2/H2 coordinate calculating means 56 to calculate the amounts of real-axis movement x and h, similarly to the normal D-cut machining process.

### Embodiment 2

Embodiment 2 of the invention will be described below with reference to FIG. 1, FIGS. 3 to 5, and FIGS. 8 and 9.

As shown in FIGS. 3 to 5, when the main set and the sub-set are different in dimensional data (the tool length or the tool diameter) of tools, the simultaneous D-cut machining process cannot be normally performed by only performing the control described in Embodiment 1. Embodiment 2 is an embodiment in which a normal machining process can be performed even when the main set and the sub-set are different in dimensional data (the tool length or the tool diameter) of the tools.

In Embodiment 2, similarly to Embodiment 1, it is necessary to switch a main axis from a speed loop control mode to a C axis control mode which is a position loop control mode as prior preparation of the virtual Y axis machining. In the sub-set, by performing the virtual plane calculation, the interpolation, and the coordinate transformation using the program values designated for the main set, inputting the X axis data to the X2 axis, inputting the X axis data of the main set to the X1 axis, and inputting the H axis data to the H1 axis, the H2 axis and the C axis, turret 1, turret 2, and the C axis moves synchronously to perform the simultaneous D-cut machining process.

In performing the double D-cut machining process with the machine shown in FIG. 1, the tool direction and the X axis direction of the virtual plane are made to be parallel to each other (G0Xx1C0H0; or G0Xx1H0; is given to each system) before machining. The tool tip (center) is located at a position separated x1 in the X axis direction from the C axis center and the C axis and the H axis are positioned relatively at 0 degrees.

After the command is executed on both the main set and the sub-set, a virtual Y axis interpolation mode command (for example, M37) is given by the machining process of the main set (system 1 $1) to establish the virtual Y axis interpolation mode, a command G17 of selecting an XY plane in which biaxial interpolation is performed with two axes of X and Y is given, and a command (for example, when “!2” is given to the main set and “! 1” is given to the sub-set using a command “!”, the main set and the sub-set are synchronously on standby) of causing the main set and the sub-set (system 2 $2) to be synchronously on standby is given.

Regarding these commands, as shown in the program example of FIG. 1, the command G17 of selecting an XY plane in which the biaxial interpolation is performed with two axes of X and Y and the virtual Y axis interpolation mode command (M37) of establishing the virtual Y axis interpolation mode may be first given and then a command (G0Xx1C0H0) of causing the tool direction and the X axis direction of the virtual plane to be parallel to each other may be given.

Subsequently, a simultaneous D-cut control mode command (for example, a command G124 H2=H1; newly defined to control the H2 axis of the sub-set with H1 axis data of the main set as a virtual command) is given. The master-slave relationship of the H axis varies depending on the combinations of the tools and thus may be changed later.

In Embodiment 2, for example, as shown in FIG. 3, a tool having a tool diameter equal to that of turret 1 but having a larger tool length is mounted on turret 2. Accordingly, when a positioning command to a machining start position (the coordinate value of the virtual Y axis) is given in this state and the tool-corrected tool center positions of the systems are calculated, the angles of the H1 axis and the H2 axis are different and the distances between the rotation centers of the H1 axis and the H2 axis and the center of a workpiece are not matched, which is not shown in the drawing. That is, due to the relationship of T2>T1 between two tool lengths, when the cutting edges of the tools in the systems are independently positioned at the machining start positions of the virtual Y axis, the rotational angles of the turret axes H1 and H2 have the relationship of h1>h2 and thus the H1, H2, and C axes cannot be made to synchronously rotate at the same time. Accordingly, when the machining process is performed in this state, both surfaces of the double D-cut become non-parallel and asymmetric surfaces. As a result, a correct machining process is not performed.

In order to perform a normal machining process under the above-mentioned tool conditions, it is necessary to make the rotational angles of both turrets to be equal with each other and to simultaneously start and end their movements. By employing this control, even when the amounts of movement y1 and y2 of the tool centers of both turrets are different, a desired machining process of cutting off both ends in the diameter direction of a workpiece can be achieved.

For this purpose, at the time point at which the calculation of an initial positioning command with tool correction is performed, the rotational angles h1 and h2 of both turrets are compared, the tool center position of the other axis (H2 axis) and the central position of the turret axis (H) are re-calculated to be matched with the larger angle (h1 in this example), and the tool axis lines of both turrets are corrected to be parallel to each other.

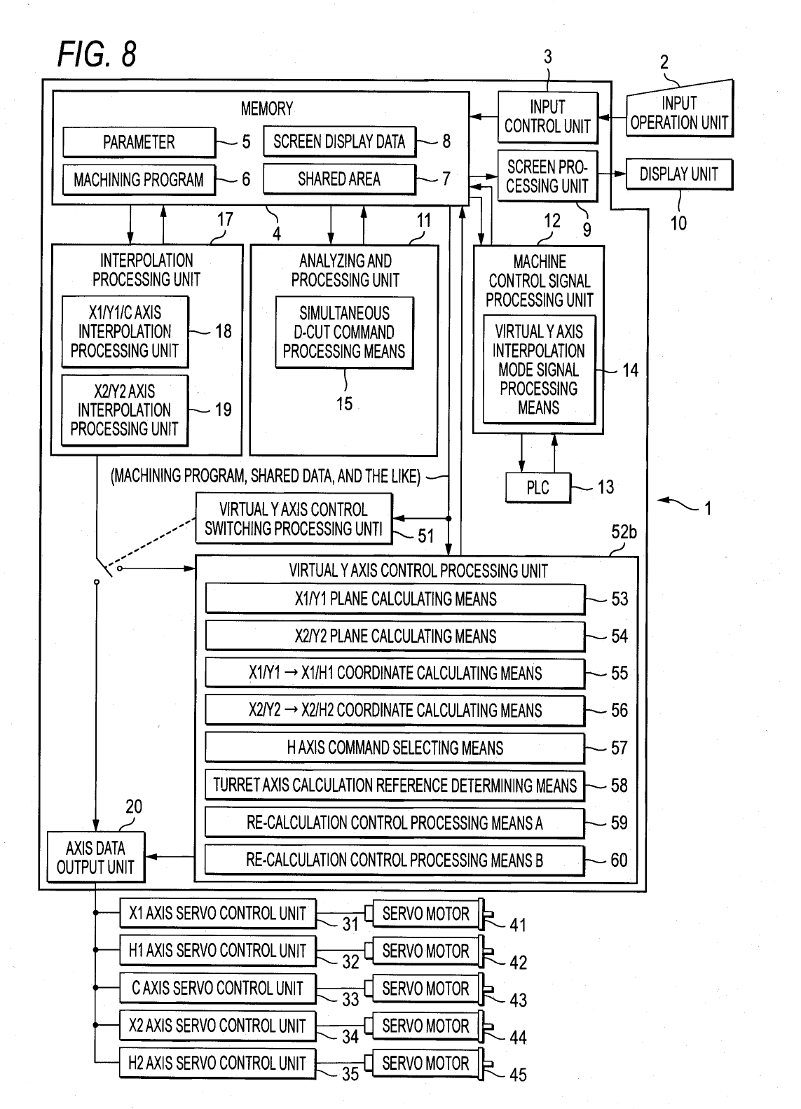

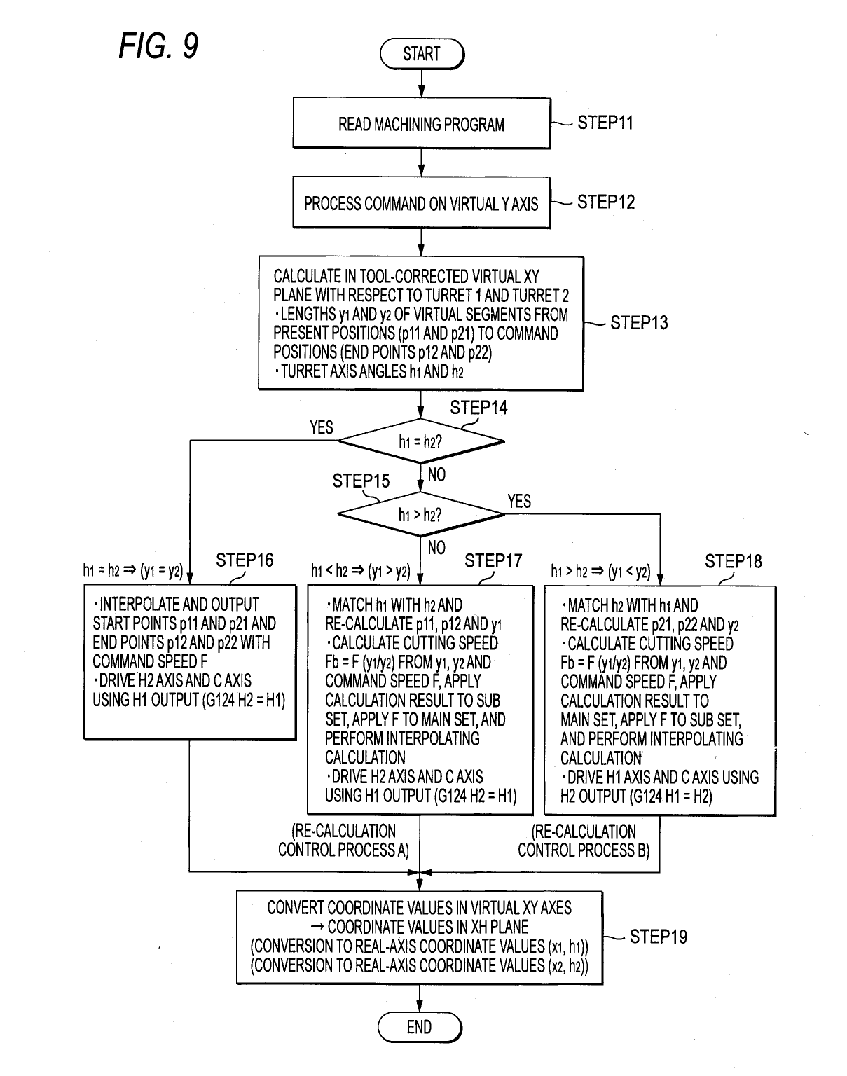

The comparison of h1 and h2 is performed by the turret axis calculation reference determining means 58 shown in FIG. 8. The process corresponding to step 17 in FIG. 9 is performed by the re-calculation control processing means A 59 shown in FIG. 8 when h1<h2 and the process corresponding to step 18 in FIG. 9 is performed by the re-calculation control processing means B 60 shown in FIG. 8 when h1>h2, whereby the tool axis lines of both turrets can be made to be parallel to each other.

The central position of the H2 axis re-calculated to be matched with the angle h1 is calculated from the rotational angle of turret 1 and the tool length L2 of turret 2 which are present as existing information. The amounts of movement y2 and y1 in the virtual Y axis are compared, y2 and h2 of the axis (H2 axis) having the larger amount of movement are interpolated with the command speed F and y1 and h1 of the axis (H1) having the smaller amount of movement are interpolated with the speed Fxy1/y2. The reason is as follows. The movements over y1 and y2 having different magnitudes should be finished at the same time, but when the axis (H1) having the smaller amount of movement is interpolated with the command speed F and the H1 axis and the H2 axis synchronously rotate at the same angular velocity, the cutting speed along y2 is higher by y2/y1 multiple times and the cutting may not be normally performed, thereby causing a problem in the machining process.

In FIG. 4 (an example where the tool diameters are different) and FIG. 5 (an example where the tool diameters and the tool lengths are different), similarly to FIG. 3 (an example where the tool lengths are different), the amounts of movement y1 and y2 re-calculated by correcting the angles h1 and h2 to be equal to each other are compared and the command speed is applied to the larger amount of movement to perform the interpolation. In driving the H axes, the axis having the larger amount of movement is used as a reference to synchronously drive the axis having the smaller amount of movement.

FIG. 8 is a block diagram illustrating an example of the configuration of the NC device according to Embodiment 2, where turret axis calculation reference determining means 58, re-calculation control processing means A 59, and re-calculation control processing means B 60 are added to the virtual Y axis control processing unit 52b of the NC device according to Embodiment 1. The other configuration is the same as the NC device according to Embodiment 1.

FIG. 9 is a flowchart illustrating an exemplary process of the machining program which can perform the simultaneous D-cut machining process using two different tools by the use of the NC device according to Embodiment 2.

A machining program is read in step 11, and a program command for the virtual Y axis is analyzed to perform a predetermined processing program in step 12. Similarly to Embodiment 1, the virtual Y axis interpolation mode ON/OFF command (M37/M38) is used as a main command. In response to M37, a virtual Y axis control switching processing unit that enables the interpolating calculation in the virtual XY plane and that selects a machining process on the XZ plane as a normal turning machine and a machining process under the control using the virtual Y axis is activated. M37/M38 is output to the outside and is input again as an external input signal again through the use of a PLC, but the commands may be switched in the NC device.

As another command, there is a command G124 for performing the simultaneous D-cut machining process. By designating H2=H1 subsequently to G124, the H2 axis is driven based on the H1 axis data. On the contrary, when H1=H2, the H1 axis is driven based on the H2 axis data. By designating only one of H1 and H2 subsequently to G124, this command is cancelled. Here, by executing G124 H2=H1, the H1 axis is defined as a reference side and the H2 axis is defined as a synchronized side.

In step 13, the X1/Y1 plane calculation means 53 and the X2/Y2 plane calculation means 54 calculate the amounts of movement (lengths of virtual segments) y1 and y2 of turret 1 and turret 2 from the present positions p11 and p21 in the virtual XY plane to the command positions p21 and p22 and the turret axis angles h1 and h2 corresponding to y1 and y2 based on the positioning command of the machining program read in step 11 using the correction data of the tools mounted on the turrets. In FIG. 3, since p11, p12, p21, and p22 represent the start points and the end points of the cutting surfaces of the D-cut but are relative signs which are sequentially changed with the machining, they are not necessarily matched with the description of the flowcharts or the like.

In step 14, the turret axis calculation reference determining means 58 compares the rotational angles h1 and h2 of both turret axes calculated in step 13. When the comparison result is h1=h2, the machining start points p11 and p21 and the end points p12 and p22 which are the tool-corrected tool center positions in the virtual XY plane, the segment lengths y1 and y2, and the rotational angles h1 and h2 of the turrets are stored in the shared area of the memory 4 and the processing flow goes to step 16. In step 16, since the process is the same as machining a workpiece with two tools having the same conditions, the X1/Y1/C axis interpolation processing means 18 interpolates the amounts of movement (the amount of movement y1 and the turret axis angle h1 in the virtual XY plane) of the axes X1, Y1, and H1 of the reference-side system with the programmed command speed F based on the data stored in the shared area 7 of the memory 4. The X2/Y2 axis interpolation processing means 19 similarly interpolates the amounts of movement (the amount of movement y2 and the turret axis angle h2 in the virtual XY plane) of the axes X1, Y2, and H2 of the synchronized-side system with the command speed F. In this case, since the H1 axis is the reference, the H2 axis and the C axis are rotationally driven using the H1 axis data (the calculated H2 axis data is not used).

In step 15, the turret axis calculation reference determining means 58 further compares the magnitudes of the values which are determined as h1≠h2 in step 14. Here, when h1>h2 is not satisfied (“No”, h1<h2), the processing flow goes to step 17. In step 17, the re-calculation control processing means A 59 re-calculates p11, p12, and y1 so as to match h1 having the smaller angle with h2. Since the result is y1>y2, the cutting speed Fb=Fxy2/y1 to be applied to the sub-set is calculated from y1, y2, and the command speed F.

The re-calculated machining start point p11, end point p12, segment length y1, and cutting speed Fb and the machining start point p21, end point p22, segment length y2, and rotational angle h2 (=h1) calculated by the X2/Y2 plane calculation means 54 are stored in the shared area 7 of the memory 4.

The X1/Y1/C axis interpolation processing means 18 interpolates the amounts of movement (the amount of movement y1 and the turret axis angle h1 in the virtual XY plane) of the axes X1, Y1, and H1 of the reference-side system with the programmed command speed F based on the data stored in the shared area 7 of the memory 4. The X2/Y2 axis interpolation processing means 19 interpolates the amounts of movement (the amount of movement y2 and the turret axis angle h2 in the virtual XY plane) of the axes H2, Y2, and H2 of the synchronized-side system with the newly-calculated cutting speed Fb. In this case, since the H1 axis is the reference, the H2 axis and the C axis are rotationally driven using the H1 axis data (the calculated H2 axis data is not used).

When the comparison result of step 15 is h1>h2, the processing flow goes to step 18 and the re-calculation control processing means B 60 re-calculates p21, p22, and y2 to match h2 having the smaller angle with h1. Since the result is y1<y2, the cutting speed Fb=Fxy1/y2 to be applied to the main set is calculated from y1, y2, and the command speed F again.

The re-calculated machining start point p21, end point p22, segment length y2, and cutting speed Fb and the machining start point p11, end point p12, segment length y1, and rotational angle h1 (=h2) of the turret calculated by the X1/Y1 plane calculation means 53 are stored in the shared area 7 of the memory 4.

The X1/Y1/C axis interpolation processing means 18 interpolates the amounts of movement (the amount of movement y1 in the virtual XY plane) of the axes X1 and Y1, of the reference-side system with the newly-calculated cutting speed Fb based on the data stored in the shared area 7 of the memory 4. The X2/Y2 axis interpolation processing means 19 interpolates the amounts of movement (the amount of movement y2 and the turret axis angle h2 in the virtual XY plane) of the axes X2, Y2, and H2 of the synchronized-side system with the programmed command speed F. In this case, since the H2 axis is the reference, G124 H1=H2; is executed instead of G124 H2=H1; to change the mode so that the H1 axis and the C axis are rotationally driven using the H2 axis data (the calculated H1 axis data is not used).

When any process of step 16 to step 18 is ended, the processing flow goes to step 19 and the X1/Y1→X1/H1 coordinate calculating means 55 and the X2/Y2→X2/H2 coordinate calculating means 56 convert the coordinate values of the X and Y axes calculated in the virtual XY coordinate system into the coordinate values x1, h1, x2, and h2 in the XH plane which is a real axis to be actually controlled. The amounts of real-axis movement are calculated based on the real-axis coordinate values converted into the coordinate values in the XH plane, the calculated amounts of movement are output to the servo control units 31 to 35 of the axes, and the corresponding motors 41 to 45 are driven, whereby the machine is operated to perform a desired machining process.

Even when the main set and the sub-set are different from each other in tool dimensional data (the tool length or the tool diameter), it is possible to complete the machining in half the time of the related art by sequentially reading and analyzing the machining program in this way and simultaneously performing the D-cut machining process on both sides using the designated sizes.

In the machining program for the simultaneous D-cut machining process, since the shapes of the D-cut of the surfaces are the same, a shaping program gives a command to only the first system as described above and the program values of the first system are used as the shape data of the second system. The temporal relationship between the start and the end of the actual simultaneous D-cut machining process or other machining processes in the first system or the second system is controlled using a synchronous standby command (for example, the command “!”).

In Embodiment 2, in determining to which of the main set and the sub-set to apply the command speed F based on the machining program and the calculated cutting speed Fb, the calculated turret axis angles h1 and h2 are compared and the comparison result is used. However, since the calculated amounts of movement y1 and y2 almost correspond to the turret axis angles h1 and h2, that is, since the relationship of y1>y2 is satisfied in the state of h1>h2 and the relationship of y1>y2 is satisfied in the state of h1<h2, the comparison result of the amounts of movement y1 and y2 may be used.

That is, when y<y2, the command speed F based on the machining program is applied to the y2-side set and the calculated command speed Fb is applied to the y1-side set. When y1>y2, the command speed F based on the machining program is applied to the y1-side set and the calculated command speed Fb is applied to the y2-side set.

### Embodiment 3

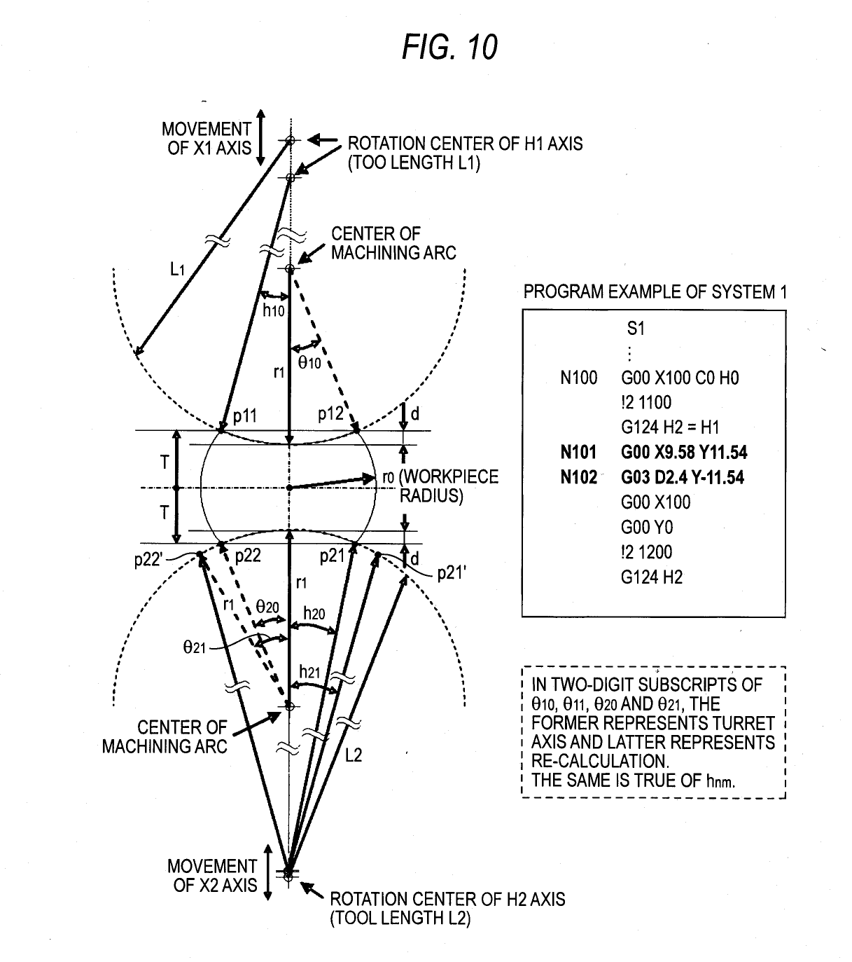

Embodiment 3 of the invention will be described below with reference to FIGS. 10 to 13.

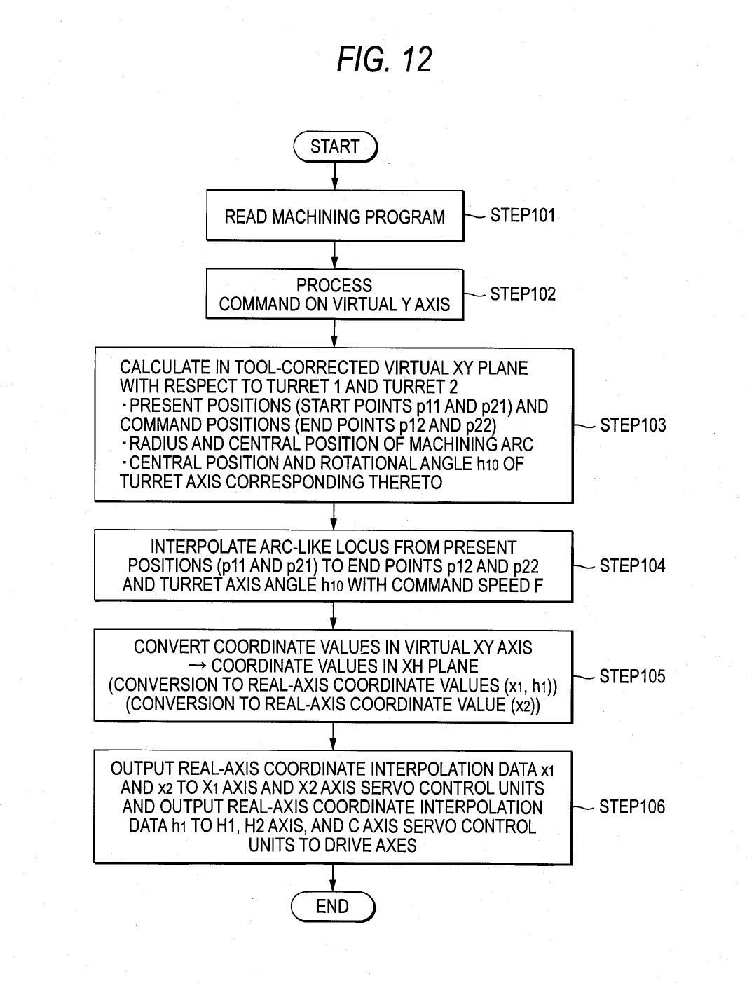

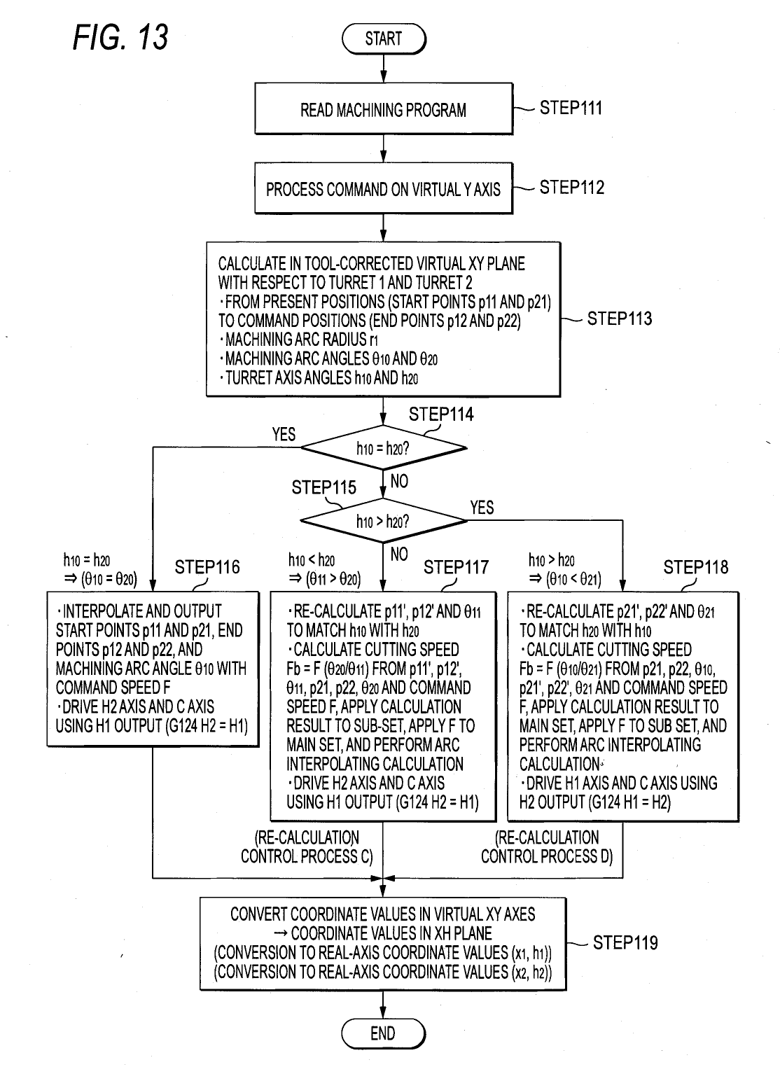

FIG. 10 shows an operational example of the simultaneous arc-like D-cut machining process in which the main set and the sub-set are different in tool dimensional data (the tool length). Here, the turret axes of the main set and the sub-set are arranged to face each other with the C axis holding a workpiece. As prior preparation of the virtual Y axis machining process, similarly to the above-mentioned embodiments, it is necessary to switch a main axis from a speed loop control mode to a C axis control mode which is a position loop control mode. In the simultaneous arc-like D-cut machining process, similarly to Embodiment 1 and Embodiment 2, the dimensional data of two tools may be equal and different. The processing flow in the former will be described later with reference to FIG. 12 and the processing flow in the latter will be described later with reference to FIG. 13.

In the normal D-cut, as described above, one side of the circular cross-section of a workpiece is cut out in a linear shape. However, the arc-like D-cut is a D-cut (terms, (linear) D-cut and arc-like D-cut, are used in this specification for the purpose of easy distinction thereof) of cutting out the circular cross-section of a workpiece in a curved shape such as a convex arc or a concave arc.

Before performing the machining process, the tool direction and the X axis direction of the virtual plane are made to be parallel to each other (G0Xx1C0H0; or G0Xx1H0; is given to each system). The tool tip (center) is located at a position separated x1 in the X axis direction from the C axis center and the C axis and the H axis are positioned relatively at 0 degrees.

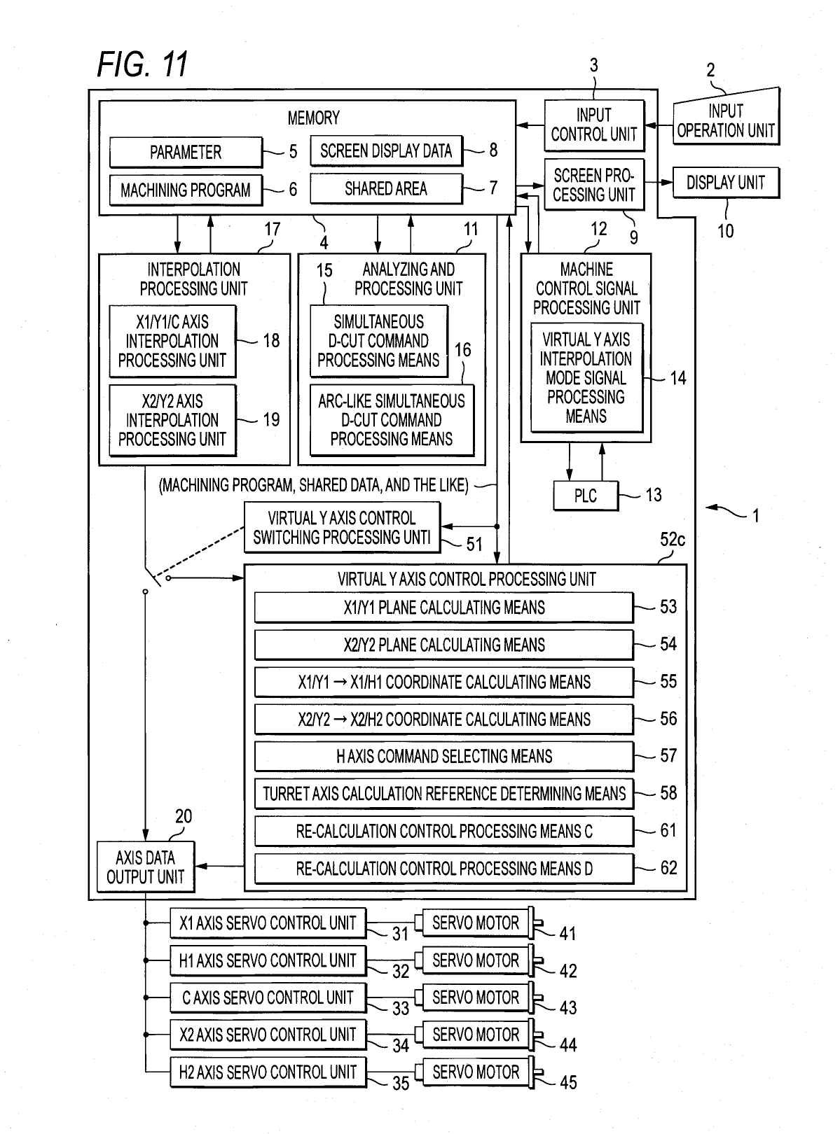

FIG. 11 is a block diagram illustrating the configuration of an NC device according to Embodiment 3. The basic configuration or operation thereof is the same as Embodiment 2, and thus an arc-like D-cut command processing unit 16 and a third virtual Y axis control processing unit 52c which are different from Embodiment 2 will be mainly described below. In the third virtual Y axis control processing unit 52c, the re-calculation control processing means A 59 and the re-calculation control processing means B 60 of the second virtual Y axis control processing unit 52b in Embodiment 2 are replaced with a re-calculation control processing means C 61 and a re-calculation control processing means D 62, and simultaneous arc-like D-cut command processing means 16 is added to the analyzing and processing unit 11.

When the virtual Y axis interpolation mode is set, the output of the interpolation processing unit 17 is input to the third virtual Y axis control processing unit 52c by the virtual Y axis control switching processing unit 51. The turret axis calculation reference determining means 58 reads the rotational angle h1 and h2 of the turrets from the calculated values in the planes of the main set and the sub-set stored in the memory 4, compares the magnitudes thereof (steps 114 and 115 in FIG. 13), determines a reference turret axis based on the comparison result, and determines one of the following calculation methods.

When two angles are equal as the determination result, the reference axis is the main set, a normal interpolation is performed, and the H2 axis and the C axis are rotationally driven using the H1 axis output data. When h1<h2 is determined as the comparison result, the normal machining process cannot be performed in this state, thus the calculation conditions are changed to perform re-calculation so that the reference axis is the sub-set as shown in step 117 of FIG. 13, the H-axis selection command is executed, and the H2 axis and the C axis are rotationally driven using the H1 axis output data. On the contrary, when h1>h2 is determined as the comparison result, the normal machining process cannot be performed in this state, thus the calculation conditions are changed to perform re-calculation so that the reference axis is the main set as shown in step 118 of FIG. 13, the H-axis selection command is executed, and the H1 axis and the C axis are rotationally driven using the H2 axis output data.

The re-calculation control processing means C 61 and the re-calculation control processing means D 62 perform the process which should be performed when the turret axis calculation reference determining means 58 determines that the magnitudes are different. The re-calculation control processing means C 61 performs the process corresponding to step 117 in FIG. 13 and the re-calculation control processing means D 62 performs the process corresponding to step 118. The re-calculation control process is performed by performing this series of processes, the calculation result is finally converted into the amounts of real-axis movement, and the amounts of real-axis movement are output to the servo control units of the axes via the axis data output unit 19 to drive the servomotors.

By operating the units in this way, even when the tools mounted on the main set and the sub-set are different in dimensional data, it is determined whether the rotational angles of both turrets are different before performing the machining process and the re-calculation is performed to achieve the same angle when they are different. Accordingly, even when both sets are operated simultaneously, the operations of the overall axes are matched and it is thus possible to perform the simultaneous D-cut machining process.

The operation of the arc-like D-cut command processing unit 16 will be described below. The arc-like D-cut command processing unit is a processing unit that analyzes program blocks commanded when it is desired to process a workpiece in a curved shape such as an arc shape instead of a planar shape to perform a similar D-cut machining process. Examples of a method of designating an arc include a method of designating the end points and the central positions as viewed from the present positions and the rotation direction, a method of similarly designating the end points, the radius values, the central direction, and the rotation direction, and a method of designating three points through which the arc passes. In the example shown in FIG. 10, the three-point designation is used and the end points as viewed from the present position (or the intersection of the circumference of a workpiece and the X axis extending from the center of the workpiece) and the concave depth are designated. In this example, G03 (counterclockwise) is given in N102, but G02 (clockwise) may be given since it can determine an arc command due to the three-passing-point designation. The rotation direction is uniquely determined regardless of the command code. The processing unit 16 can reversely calculate the radius and the central position of the machining arc from the command values of the corresponding block. In the three-passing-point designation method, the distance (X value) of both ends of the arc, which is formed in the workpiece having a known radius, from the center of the workpiece and the concave depth (X value) can be designated. In this method, the coordinate values of N101 in FIG. 10 can be calculated in the NC device without manually calculating the coordinate values.

A designated arc locus can be drawn in the virtual XY plane based on the data and the coordinate values of the respective control points can be calculated by arc interpolation.

After the above-mentioned command is executed on both the main set and the sub-set, a virtual Y axis interpolation mode command (for example, M37) is given by the machining process of the main set (system 1) to establish the virtual Y axis interpolation mode, a command G17 of selecting an XY plane in which biaxial interpolation is performed with two axes of X and Y is given. Then, a simultaneous D-cut control mode command (for example, G124 H2≡H1, which is a virtual command, newly defined to control the H2 axis of the sub-set using the H1 axis data of the main set) is given. Here, the master-slave relationship of the H axis varies depending on the combinations of the tools and thus may be changed later. In Embodiment 3, the case shown in FIG. 10 is described as an example. In this case, as shown in the drawing, a tool having the same tool diameter as turret 1 but a larger tool length is mounted on turret 2.

When a positioning command to the machining start position (the coordinate value of the virtual Y axis) is given in this state and the tool-corrected tool center positions of the systems are calculated, the angles of the H1 axis and the H2 axis are different and the distances between the rotation centers of the H1 axis and the H2 axis and the center of a workpiece are not matched, which is not shown in the drawing. That is, due to the relationship of L2>L1 between two tool lengths, when the cutting edges of the tools in the systems are independently positioned at the machining start positions of the virtual Y axis, the rotational angles of the turret axes H1 and H2 have the relationship of h₁₀>h₂₀ and thus the H1, H2, and C axes cannot be made to synchronously rotate at the same time. Accordingly, when the machining process is performed in this state, both surfaces of the double arc-like D-cut become final surfaces having different curvatures. As a result, a correct machining process is not performed.

Here, a problem in that the angles of the H1 axis and the H2 axis are different and the distances between the rotation centers of the H1 axis and the H2 axis and the center of a workpiece are not matched is solved by independently driving the H1 axis and the H2 axis and operating the C axis using the H axis rotation control data of the turret axis having the larger actual amount of movement.

In order to perform a normal machining process under the above-mentioned tool conditions, it is necessary to match the rotational angles of both turrets with each other and to simultaneously start and end their movements. By employing this control, even when the arc start points p11 and p21 and the arc end points p12 and p22 of the tool centers are different, a desired machining process of cutting off both ends in the diameter direction of a workpiece can be achieved.

For this purpose, at the time point at which the calculation of an initial positioning command with tool correction is performed, the rotational angles h₁₀ and h₂₀ of both turrets are compared, the tool center position of the other axis (H2 axis) and the central position of the turret axis (H2) are re-calculated to be matched with the larger angle (h₁₀ in this example), and the tool axis lines of both turrets are corrected to be parallel to each other.

The central position of the H2 axis re-calculated to be matched with the angle h₁₀ is calculated from the rotational angle of turret 1 and the tool length L2 of turret 2 which are present as existing information. The rotational angles h₁₀ and h₂₀ in the virtual Y axis are compared, the arc start point p21, the arc end point p22, and the rotational angle h₂₀ of the axis (H2 axis) having the larger angle are interpolated with the command speed F and the arc start point p11, the arc end point p12, and the rotational angle h₁₀ of the axis (H1) having the smaller rotational angle are interpolated with the speed F×h₁₀/h₂₀. The reason is as follows. The movements over the length from the start point p11 to the end point p12 and the length from the start point p21 to the end point p22 having different magnitudes should be finished at the same time, but when the axis (H1) having the smaller rotational angle is interpolated with the command speed F, the rotation speed of the H2 axis over h₂₀ is higher by h₂₀/h₁₀ multiple times and the cutting may not be normally performed, thereby causing a problem in the machining process.

FIG. 12 shows an example of the flowchart illustrating the processing flow of the machining program when the tools having the same dimensional data are used in the NC device according to Embodiment 3, where an arc-like machining process, that is, an arc-like D-cut machining process, is performed on the surface of a workpiece and the processing flow is substantially the same as shown in FIG. 6.

Similarly to Embodiment 1, the sub-set performs the virtual plane calculation, the arc interpolation, or the real-axis coordinate transformation using the program values commanded for the main set and turret 1, turret 2, and the C axis are synchronously operated to perform the simultaneous arc-like D-cut machining process by inputting X axis data to the X2 axis, inputting the X axis data for the main set to the X1 axis, and inputting the H axis data to the H1 axis, the H2 axis, and the C axis.

A machining program is read in step 101, and a program command for the virtual Y axis is analyzed to perform a predetermined processing program in step 102. A virtual Y axis interpolation mode ON/OFF command, that is, M37/M38 in this embodiment, is used as the command for the virtual Y axis. In response to M37, a switching processing unit that enables the interpolating calculation in the virtual XY plane and that selects a machining process on the XZ plane as a normal turning machine and a machining process under the control using the virtual Y axis is activated. The method of outputting M37/M38 to the outside and inputting the command as an external input signal to the NC again through the use of a PLC is employed, but the command may be switched in the NC device.

In order to perform the simultaneous D-cut machining process, a G command such as G124 of selecting the input of an H axis command and a C axis command is newly added as another command. By designating H2=H1 subsequently to G124, the H2 axis is analyzed to be driven based on the H1 axis data. On the contrary, when H1=H2, the H1 axis is analyzed to be driven based on the H2 axis data. By designating only one of H1 and H2 subsequently to G124, these commands are cancelled. This G command can be set arbitrarily.

When the machining paths of two tools mounted in the same way are the same, the turret rotational angles and the rotation speeds are the same. Accordingly, by executing G124 H2=H1; as a basic command, the H1 axis is defined as a reference side and the H2 axis is defined as a synchronized side.

In step 103, regarding the command positions of the turret 1 and turret 2, the tool-corrected command positions p12 and p22, the radii and the central positions of the machining arcs, and the central position and the angle h₁₀ of the turret axis are calculated from the present positions p11 and p21 in the virtual XY plane to based on a positioning command of the machining program read in step 101. In FIG. 12, since p11, p12, p21, and p22 represent start points and end points of the cutting surfaces of the arc-like D-cut but are relative signs which are sequentially changed with the machining, they are not necessarily matched with the description of the flowcharts or the like.

In step 104, the positions in the virtual XY plane and the turret axis angle h₁₀ calculated in step 103 are interpolated with a programmed command speed F.

In step 105, the arc interpolated values in the virtual XY coordinate system are converted into coordinate values in the XH plane which is a real axis to be actually controlled so as to drive a motor to be controlled.

In step 106, the amounts of real-axis movement are calculated based on the real-axis coordinate values obtained by converting the coordinate values in the virtual XY plane into the coordinate values in the XH plane, the calculated amounts of movement are output to the servo control units of the axes, and the corresponding motors are driven, whereby the machine is operated to perform a desired machining process. By sequentially reading and analyzing the machining program in this way and simultaneously performing the arc-like D-cut machining process on both sides using the designated sizes, it is possible to complete the machining in half the time of the related art.

FIG. 13 is a flowchart illustrating an example of the processing flow of machining program of performing a simultaneous arc-like D-cut machining process using two different tools in the NC device according to Embodiment 3. A machining program is read in step 111, and a program command for the virtual Y axis is analyzed to perform a predetermined processing program in step 112. Similarly to Embodiment 1 and Embodiment 2, a virtual Y axis interpolation mode ON/OFF command (M37/M38) is used as the main command. In response to M37, a virtual Y axis control switching processing unit that enables the interpolating calculation in the virtual XY plane and that selects a machining process on the XZ plane as a normal turning machine and a machining process under the control using the virtual Y axis is activated. The method of outputting M37/M38 to the outside and inputting the command as an external input signal to the NC again through the use of a PLC is employed, but the commands may be switched in the NC device.

As another command, there is the same command G124 as used to perform the simultaneous D-cut machining process. By designating H2=H1 subsequently to G124, the H2 axis is driven based on the H1 axis data. On the contrary, when H1=H2, the H1 axis is driven based on the H2 axis data. By designating only one of H1 and H2 subsequently to G124, this command is cancelled. Here, by executing G124 H2=H1, the H1 axis is defined as a reference side and the H2 axis is defined as a synchronized side.

As a relevant command, there is an arc command for performing the arc-like D-cut machining process. In the arc-like D-cut machining process, a similar three-point command which is similar to the three-point designation and which can specify an arc is used for the purpose of simplifying the program. Specifically, after the arc start point is positioned, such a command is expressed by adding the end point coordinate values, which are obtained by inverting the polarity of the Y-axis coordinate value of the arc start point, and the relative X coordinate value from a line connecting the start point and the end point to the bottom of the arc to the G02 or G03 indicating the arc command. By using this method, the start point position can be calculated in the NC device without performing manual calculation. The radius and the central position of the arc can be easily calculated from the relationship between the positions of both ends of the arc and the line crossing the workpiece (the line connecting both ends of the concave surface=the distance from the center of the workpiece), by adding the position of the bottom position of the concave surface. Since this method is similar to the three-passing-point designation method, the rotation direction is uniquely determined regardless of the command code. This method may be replaced with another designation method.

In step 113, the moving angles (rotational angles) h₁₀ and h₂₀ of turret 1 and turret 2 from the present positions p11 and p21 in the virtual XY plane to the command positions p21 and p22 are calculated based on the positioning command of the machining program read in step 111 using the correction data of the tools mounted on the turrets. The turret axis angles are determined along with the central positions of the turret axes based on the start point positions and the end point positions of the machining arcs and the tool lengths. In FIG. 10, since p11, p12, p21, and p22 represent the start points and the end points of the cutting surfaces of the D-cut but are relative signs which are sequentially changed with the machining, they are not necessarily matched with the description of the flowcharts or the like.

In step 114, the rotational angles h₁₀ and h₂₀ of both turret axes calculated in step 113 are compared. When the comparison result is h₁₀=h₂₀, the processing flow goes to step 116. In step 116, since the process is the same as machining a workpiece with two tools having the same conditions, the amounts of arc-like movement of the axes X1, Y1, and H1 of the reference-side system are interpolated with the programmed command speed F and the amounts of arc-like movement of the axes X1, Y2, and H2 of the synchronized-side system are similarly interpolated with the command speed F. The interpolation results are used as corresponding axis data except for the H2 axis. In this case, since the H1 axis is the reference, the H2 axis and the C axis are rotationally driven using the H1 axis data.

In step 115, the magnitudes of the values which are determined as h₁₀≠H₂₀ in step 114 are compared again. Here, when h₁₀>h₂₀ is not satisfied (“No”, h₁₀<h₂₀), the processing flow goes to step 117. In step 117, p11′, p12′, and θ₁₁ are re-calculated so as to match h₁₀ having the smaller angle with h₂₀. p11′ and p12′ are determined with the intersections of the line having the tool length L1×cos(h₁₀) as an X coordinate value and the machining arc and the angle θ₁₁ of the machining arc can be calculated from the coordinate values of p11′ and p12′ and the radius of the machining arc at that time. Since the result is θ₁₁>θ₂₀, the cutting speed Fb=F×θ₁₁/θ₂₀ to be applied to the sub-set is calculated from θ₁₁, θ₂₀, and the command speed F. F is applied to the main set to perform the arc interpolation. The amounts of movement of the axes X1, Y1, and H1 of the reference-side system are arc-interpolated with the programmed command speed F and the amounts of movement of the axes X2, Y2, and H2 of the synchronized-side system are arc-interpolated with the newly-calculated cutting speed Fb. The interpolation results are used as corresponding axis data except for the H2 axis. In this case, since the H1 axis is the reference, the H2 axis and the C axis are rotationally driven using the H1 axis data.

Here, the arc length to be compared is calculated by the arc radius×the angle (rad). The arc diameter is the machining radius and is the same in both sides. Accordingly, the difference between the start point position and the end point position in the arc-like D-cut corresponds to the angle, but is the difference in virtual coordinate value itself in the linear D-cut.

Here, when the amounts of cutting movement are different, the change in cutting speed does not cause any problem in a control operation. However, when the set having the smaller amount of movement performs the cutting process with the command speed, the actual machining speed may increase in the set having the larger amount of movement, thereby disabling the cutting process. So as not to cause this case, the command speed should be applied to the larger amount of movement, a speed in proportion thereof should be calculated and applied to the smaller amount of movement, the re-calculation is performed so as to perform the cutting at the speeds corresponding to the lengths.

When the comparison result of step 115 is h₁₀>h₂₀, the processing flow goes to step 118 and p21, p22, and θ₂₁ are re-calculated to match h₂₀ having the smaller angle with h₁₀. Since the result is θ₁₀<θ₂₁, the cutting speed Fb=F×θ₁₀/θ₂₁ to be applied to the main set is calculated from θ₂₁, θ₁₀, and the command speed F again. F is applied to the main set to perform the arc interpolation. The amounts of movement of the axes X2, Y2, and H2 of the reference-side system are arc-interpolated with the programmed command speed F, the amounts of movement of the axes X1, Y1, and H1 of the synchronized-side system are arc-interpolated with the newly-calculated cutting speed Fb. The interpolation results are used as corresponding axis data except for the H1 axis. In this case, since the H2 axis is the reference, G124 H1=H2; is executed instead of G124 H2=H1; to change the mode so that the H1 axis and the C axis are rotationally driven using the H2 axis data.

When any process of step 116 to step 118 is ended, the processing flow goes to step 119. Here, the coordinate values of the X and Y axes calculated in the virtual XY coordinate system are converted into the coordinate values x1, h1, x2, and h2 in the XH plane which is a real axis to be actually controlled, the amounts of real-axis movement are calculated based on the real-axis coordinate values converted into the coordinate values in the XH plane, the calculated amounts of movement are output to the servo control units of the axes, and the corresponding motors are driven, whereby the machine is operated to perform a desired machining process. By sequentially reading and analyzing the machining program in this way and simultaneously performing the D-cut machining process on both sides with the designated sizes, it is possible to complete the machining in half the time of the related art.

In the machining program for the simultaneous D-cut machining process, since the shapes of the arc-like D-cut of the surfaces are the same, a shaping program gives a command to only the first system as described above and the program values of the first system are used as the shape data of the second system. The temporal relationship between the start and the end of the actual simultaneous D-cut machining process or other machining processes in the first system or the second system is controlled using a synchronous standby command.

In the above-mentioned embodiments, regarding two turret axes and the C axis, the synchronized-side turret axis is synchronously rotated at the same angle using the movement data of the reference-side turret axis. However, when two turret axes are independently controlled and are rotationally driven by the different rotational angle for the same time, it is possible to cope with such a case by the use of a selective control of using the drive data of the turret axes of the sets without performing re-calculation and acquiring the C axis drive data from the turret axis having the larger rotational angle.

### INDUSTRIAL APPLICABILITY

The numerical control device according to the invention can be suitably used to control a machine in which a main set including an X1 axis, a Z1 axis, and a first turret axis (H1 axis) and a sub-set including an X2 axis, a Z2 axis, and a second turret axis (H2 axis) are arranged to be point symmetric with respect to a C axis.

### REFERENCE SIGNS LIST

6: MACHINING PROGRAM
7: SHARED AREA
11: ANALYZING AND PROCESSING UNIT
12: MACHINE CONTROL SIGNAL PROCESSING UNIT
13: PLC
14: VIRTUAL Y AXIS INTERPOLATION MODE SIGNAL PROCESSING MEANS
15: SIMULTANEOUS D-CUT COMMAND PROCESSING MEANS
16: SIMULTANEOUS ARC-LIKE D-CUT COMMAND PROCESSING MEANS
18: X1/Y1/C AXIS INTERPOLATION PROCESSING UNIT
19: X2/Y2 AXIS INTERPOLATION PROCESSING UNIT
20: AXIS DATA OUTPUT UNIT
51: VIRTUAL Y AXIS CONTROL SWITCHING UNIT
52a: FIRST VIRTUAL Y AXIS CONTROL PROCESSING UNIT
52b: SECOND VIRTUAL Y AXIS CONTROL PROCESSING UNIT
52c: THIRD VIRTUAL Y AXIS CONTROL PROCESSING UNIT
53: X1/Y1 PLANE CALCULATING MEANS
54: X2/Y2 PLANE CALCULATING MEANS
55: X1/Y1→X1/H1 COORDINATE CALCULATING MEANS
56: X2/Y2→X2/H2 COORDINATE CALCULATING MEANS
57: H AXIS COMMAND SELECTING MEANS
58: TURRET AXIS CALCULATION REFERENCE DETERMINING MEANS
59: RE-CALCULATION CONTROL PROCESSING MEANS A
60: RE-CALCULATION CONTROL PROCESSING MEANS B
61: RE-CALCULATION CONTROL PROCESSING MEANS C
62: RE-CALCULATION CONTROL PROCESSING MEANS D

1. A numerical control device that controls a machine in which a main set including an X1 axis, a Z1 axis and a first turret axis and a sub-set including an X2 axis, a Z2 axis and a second turret axis are arranged to be point-symmetric with respect to a C axis,
wherein each of the turret axis of the main set and the turret axis of the sub-set are selectively designated as a reference side and a synchronized side and a simultaneous D-cut control mode command for selecting a mode in which both turret axes are simultaneously actuated in synchronization using the output of the turret axis of one of the sets is set;
wherein the numerical control device comprises,
simultaneous D-cut command processing means for analyzing and executing the simultaneous D-cut control mode command,
X1/Y1/C axis interpolation processing means for performing an interpolation process on the main set,
X2/Y2 axis interpolation processing means for performing an interpolation process on the sub-set, and
H axis command selecting means for selecting from which of the main set and the sub-set to acquire rotational angle control data of the turret axes and the C axis; and
wherein when the simultaneous D-cut control mode command is executed, the H axis command selecting means selects from which of the main set and the sub-set to acquire the rotational angle control data of the turret axes and the C axis, and the machine is controlled to simultaneously perform a D-cut machining process on to surfaces of a workpiece held by the C axis based on the selected data.

2. The numerical control device according to claim 1, further comprising:
turret axis calculation reference determining means for comparing a turret axis angle of the main set having a tool mounted thereon and a turret axis angle of the sub-set having a tool mounted thereon with each other and determining whether both turret axis angles are different from each other; and
re-calculation control processing means for re-calculating an actual amount of movement of the tool and re-calculating a command speed to be given to the turret axis having the larger turret axis angle so that the smaller turret axis angle becomes equal to the larger turret axis angle when the turret axis calculation reference determining means determines that both turret axis angles are different from each other,
wherein the H axis command selecting means selects the set having the smaller turret axis angle from which the rotational angle control data of both turret axes and the C axis are obtained.

3. The numerical control device according to claim 1, further comprising:
turret axis calculation reference determining means for comparing an actual amount of movement of a tool of the main set having the tool mounted thereon and an actual amount of movement of a tool of the sub-set having the tool mounted thereon with each other and determining whether the actual amounts of movement of the tools of both turret axes are different from each other; and
re-calculation control processing means for re-calculating a command speed to be given to the turret axis having the smaller amount of movement when the turret axis calculation reference determining means determines that the actual amounts of movement of the tools of both turret axes after correction of the tools are different from each other,
wherein the H axis command selecting means selects the set having the larger actual amount of movement of the tool from which the rotational angle control data of both turret axes and the C axis are obtained.

4. The numerical control device according to claim 1, wherein the D-cut machining process on the two surfaces is a process of performing a planar machining process on the two surfaces in the diameter direction of the workpiece held by the C axis.

5. The numerical control device according to claim 1,
wherein the D-cut machining process on the two surfaces is a process of performing a curved machining process on the two surfaces of the workpiece held by the C axis.
